(19) United States
(12) Patent Application Publication
(10) Pub. No.: US 2026/0340640 A1
(43) Pub. Date: Oct. 29, 2026

(54) RISK DETERMINATION SYSTEM AND METHOD

(71) Applicant: FACETROM LTD., Tel Aviv (IL)

(72) Inventors: Amir UZIEL, Modiin (IL); Elior KALFON, Tel Aviv (IL); Uri LIPOWEZKY, Kiryat Ono (IL); Ido PELEG, Tel Aviv (IL); Irit PELEG, Netanya (IL)

(21) Appl. No.: 19/482,787

(22) PCT Filed: Apr. 15, 2024
(86) PCT No.: PCT/IL2024/050366

§ 371 Date: Nov. 10, 2025

Related U.S. Application Data
(60) Provisional application No. 63/501,150, filed on May 10, 2023.

(51) Int. Cl. G06Q 20/40; G06Q 10/1053; G06Q 40/08; G06V 10/774; G06V 20/52; G06V 40/16

(52) U.S. Cl. CPC G06Q 20/4016; G06Q 10/1053; G06Q 40/084; G06Q 40/085; G06Q 40/09; G06V 10/774; G06V 20/52; G06V 40/168

(57) ABSTRACT

A system for determining a risk score associated with a transaction, the system comprising a processing circuitry configured to: obtain: (a) an unsupervised machine learning model capable of receiving an image of a person associated with the transaction and calculating an embedding vector for the image, (b) a supervised machine learning model capable of receiving an embedding vector of the image and determining the risk score associated with the transaction being performed for the person, and (c) the image of the person; calculate the embedding vector of the image by utilizing the image of the person and the unsupervised machine learning model; and determine the risk score associated with the transaction being performed for the person by utilizing the calculated embedding vector and the supervised machine learning model.

### TECHNICAL FIELD

The present invention relates to the field of risk determination system and method.

### BACKGROUND

About 1.4 billion adults in the world, mainly in emerging and developing countries, are either unbanked, underbanked and/or have no credit history, i.e., practically they cannot get an approval for a transaction (such as: a financial or an insurance transaction) from formal channels. Since service providing institutes reject about 90% of the service requests applied by the people with “thin file”. 87% of current loans, for example, in these countries are received nowadays from non-formal channels, usually involving very high interest rates. In the formal channels, only people with sufficient credit history are practically provided with financial and insurance services; Nevertheless, the rate of borrowers that partially or fully miss their installment due date usually ranges between 4% and 10%, depending on the country and region. As an example, Mexico and Brazil hold the fraud record of fraudulent accounts within Latin America, where 20% of new user accounts created are fraudulent. These statistics put the region at almost twice the global level of fraudulent accounts. Among these borrowers, one can find fraudulent users who intentionally commit malicious actions.

Current risk assessment and/or risk determination solutions rely on the service provider collecting various data points about the person requesting the transaction, as part of a process termed Know Your Customer (KYC). The service provider employing the KYC process, aims to evaluate the level of risk (for the service provider) inherited by that person, in case the requested transaction is provided. Traditional data points can include a survey performed by a representative visiting the person's home, a questionnaire filled-in by the person, federal bureau credit score, income statements, bank statements, telecom payments, permanent home address, age, education, permanent employment, employer and role, etc. The traditional risk determination process classifies the person into one of many groups (or classes), and the evaluation is based upon the risk of the specific group relying on significant historical statistics collected by the service provider. This process is cumbersome and costly; moreover, the process discriminates the users by the group they belong to; moreover, a transaction request submitted by a person having no credit history, i.e., no credit score, would most likely be rejected, as the service provider cannot evaluate the risk involved (for itself). These current risk assessments and/or risk determinations solutions can be employed in other domains to provide risk associated with a transaction for a person which is relatively unknown to the service provider. Examples of these additional domains can include: security-for example: assessing risk associated with approving a clearance level for a person, Human Resources (HR)-for example: evaluating the reliability of a candidate, or any other domain where a service provider is required to assess risk associated with a service.

Thus, there is a need for a novel technique for an automatic risk assessment and/or risk determination system and method that can enable service providers to fulfill the needs for customers which are relatively unknown to the service provider, for example: those customers who lack credit histories, while at the same time protecting the service providers from fraudulent users.

### GENERAL DESCRIPTION

In accordance with a first aspect of the presently disclosed subject matter, there is provided a system for determining a risk score associated with a transaction, the system comprising a processing circuitry configured to: obtain: (a) an unsupervised machine learning model capable of receiving an image of a person associated with the transaction and calculating an embedding vector for the image, (b) a supervised machine learning model capable of receiving an embedding vector of the image and determining the risk score associated with the transaction being performed for the person, and (c) the image of the person; calculate the embedding vector of the image by utilizing the image of the person and the unsupervised machine learning model; and determine the risk score associated with the transaction being performed for the person by utilizing the calculated embedding vector and the supervised machine learning model.

In some cases, the image of the person is one of: (a) a static two-dimensional facial image of the person associated with the transaction, (b) a static three-dimensional facial image of the person associated with the transaction, (c) a static two-dimensional image of the person associated with the transaction, (d) a static three-dimensional facial model of the person associated with the transaction, (e) a two-dimensional static facial model of the person associated with the transaction, (f) a static three-dimensional image of the person associated with the transaction, (g) a moving image of the person associated with the transaction, (h) an analog video clip of the person associated with the transaction, and (i) a digital video clip of the person associated with the transaction.

In some cases, the at least one static three-dimensional facial image of the person associated with the transaction is generated from one or more of: (a) a hologram of the person associated with the transaction, and (b) a static two-dimensional image of the person associated with the transaction, and (c) a static three-dimensional image of the person associated with the transaction.

In some cases, the image of the person is captured from one or more of: (a) a video recording of the person associated with the transaction, (b) a static two-dimensional image of the person associated with the transaction, or (c) a static three-dimensional image of the person associated with the transaction.

In some cases, (a) the processing circuitry is further configured to obtain one or more properties of the transaction being performed for the person, (b) the supervised machine learning model is also capable of receiving one or more properties of the transaction being performed for the person, and (c) the determination of the risk score associated with the transaction being performed for the person also utilizes the one or more properties of the transaction being performed for the person.

In some cases, (a) the transaction is a financial transaction for approving a financial service to the person, and (b) the properties of the financial transaction include one or more of: financial service starting date, financial service ending date, financial service currency, financial service amount, financial service interest rate, or number of installments for the financial service.

In some cases, (a) the transaction is an insurance transaction for approving an insurance policy to the person, and (b) the properties of the insurance transaction include one or more of: insurance policy amount, insurance policy currency, insurance policy starting date, insurance policy ending date, insurance policy premium, or insurance policy number of installments.

In some cases, (a) the transaction is a security transaction for clearance for the person, and (b) the properties of the security transaction include one or more of: transaction date, existing levels of security clearance for the person, level of clearance requested for the person, historical travel information for the person, family members information for the person, friends information for the person, historical publications of the person, historical security information for the person, or counter-security activities of the person.

In some cases, (a) the transaction is a human resource transaction for recruitment of the person into a team, and (b) the properties of the human resource transaction include one or more of: team size, images of the team members, team task, professions of the team members, or gender of the team members.

In some cases, (a) the processing circuitry is further configured to obtain facial features extracted from the image of the person associated with the transaction, (b) the supervised machine learning model is also capable of receiving the facial features, and (c) the determination of the risk score associated with the transaction being performed for the person also utilizes the facial features.

In some cases, the facial features include one or more of: facial landmarks features extracted from a face of the person appearing in the image, biological features of the person appearing in the image, genetic system features of the person appearing in the image, hormonal system features of the person appearing in the image, immune system features of the person appearing in the image, psychological features of the person appearing in the image, or emotional features of the person appearing in the image.

In some cases, at least one of the facial features is extracted from the image using a facial image feature extracting machine learning model.

In some cases, (a) the processing circuitry is further configured to obtain additional features extracted from the image of the person associated with the transaction, (b) the supervised machine learning model is also capable of receiving the additional features, and (c) the determination of the risk score associated with the transaction being performed for the person also utilizes the additional features.

In some cases, the additional features include one or more of: garments features of at least part of garments worn by the person appearing in the image, body-part features of at least part of a body of the person appearing in the image, palm features of at least part of a palm of the person appearing in the image, or background features extracted from a background of the image.

In some cases, at least one of the additional features is extracted from the image using an image feature extracting machine learning model.

In some cases, the unsupervised machine learning model is a pre-trained unsupervised machine learning model, pre-trained utilizing an unlabeled training-data set comprising of a plurality of unlabeled images.

In some cases, at least some of the unlabeled images are gathered randomly from publicly available images.

In some cases, the unlabeled images comprise of images of persons from a given region.

In some cases, the supervised machine learning model is trained utilizing a labeled training-data comprising of a plurality of records, each record comprising an embedding vector of a given image of a given person associated with a given transaction, and wherein at least some given records of the records are associated with a label indicative of a given risk score associated with the corresponding given transaction being performed for the given person.

In some cases, the supervised machine learning model is trained utilizing a labeled training-data comprising of a plurality of records, each record comprising: (i) an embedding vector of a given image of a given person associated with a given transaction, and (ii) one or more properties of the given transaction, and wherein at least some given records of the records are associated with a label indicative of a given risk score associated with the corresponding given transaction being performed for the given person.

In some cases, the supervised machine learning model is based on one or more neural network techniques.

In some cases, the person is one or more of: a male, or a female.

In accordance with a second aspect of the presently disclosed subject matter, there is provided a method for determining a risk score associated with a transaction, the method comprising: obtaining, by a processing circuitry: (a) an unsupervised machine learning model capable of receiving an image of a person associated with the transaction and calculating an embedding vector for the image, (b) a supervised machine learning model capable of receiving an embedding vector of the image and determining the risk score associated with the transaction being performed for the person, and (c) the image of the person; calculating, by the processing circuitry, the embedding vector of the image by utilizing the image of the person and the unsupervised machine learning model; and determining, by the processing circuitry, the risk score associated with the transaction being performed for the person by utilizing the calculated embedding vector and the supervised machine learning model.

In some cases, the image of the person is one of: (a) a static two-dimensional facial image of the person associated with the transaction, (b) a static three-dimensional facial image of the person associated with the transaction, (c) a static two-dimensional image of the person associated with the transaction, (d) a static three-dimensional facial model of the person associated with the transaction, (e) a two-dimensional static facial model of the person associated with the transaction, (f) a static three-dimensional image of the person associated with the transaction, (g) a moving image of the person associated with the transaction, (h) an analog video clip of the person associated with the transaction, and (i) a digital video clip of the person associated with the transaction.

In some cases, the at least one static three-dimensional facial image of the person associated with the transaction is generated from one or more of: (a) a hologram of the person associated with the transaction, and (b) a static two-dimensional image of the person associated with the transaction, and (c) a static three-dimensional image of the person associated with the transaction.

In some cases, the image of the person is captured from one or more of: (a) a video recording of the person associated with the transaction, (b) a static two-dimensional image of the person associated with the transaction, or (c) a static three-dimensional image of the person associated with the transaction.

In some cases, (a) the processing circuitry is further configured to obtain one or more properties of the transaction being performed for the person, (b) the supervised machine learning model is also capable of receiving one or more properties of the transaction being performed for the person, and (c) the determination of the risk score associated with the transaction being performed for the person also utilizes the one or more properties of the transaction being performed for the person.

In some cases, (a) the transaction is a financial transaction for approving a financial service to the person, and (b) the properties of the financial transaction include one or more of: financial service starting date, financial service ending date, financial service currency, financial service amount, financial service interest rate, or number of installments for the financial service.

In some cases, (a) the transaction is an insurance transaction for approving an insurance policy to the person, and (b) the properties of the insurance transaction include one or more of: insurance policy amount, insurance policy currency, insurance policy starting date, insurance policy ending date, insurance policy premium, or insurance policy number of installments.

In some cases, (a) the transaction is a security transaction for clearance for the person, and (b) the properties of the security transaction include one or more of: transaction date, existing levels of security clearance for the person, level of clearance requested for the person, historical travel information for the person, family members information for the person, friends information for the person, historical publications of the person, historical security information for the person, or counter-security activities of the person.

In some cases, (a) the transaction is a human resource transaction for recruitment of the person into a team, and (b) the properties of the human resource transaction include one or more of: team size, images of the team members, team task, professions of the team members, or gender of the team members.

In some cases, (a) the processing circuitry is further configured to obtain facial features extracted from the image of the person associated with the transaction, (b) the supervised machine learning model is also capable of receiving the facial features, and (c) the determination of the risk score associated with the transaction being performed for the person also utilizes the facial features.

In some cases, the facial features include one or more of: facial landmarks features extracted from a face of the person appearing in the image, biological features of the person appearing in the image, genetic system features of the person appearing in the image, hormonal system features of the person appearing in the image, immune system features of the person appearing in the image, psychological features of the person appearing in the image, or emotional features of the person appearing in the image.

In some cases, at least one of the facial features is extracted from the image using a facial image feature extracting machine learning model.

In some cases, (a) the processing circuitry is further configured to obtain additional features extracted from the image of the person associated with the transaction, (b) the supervised machine learning model is also capable of receiving the additional features, and (c) the determination of the risk score associated with the transaction being performed for the person also utilizes the additional features.

In some cases, the additional features include one or more of: garments features of at least part of garments worn by the person appearing in the image, body-part features of at least part of a body of the person appearing in the image, palm features of at least part of a palm of the person appearing in the image, or background features extracted from a background of the image.

In some cases, at least one of the additional features is extracted from the image using an image feature extracting machine learning model.

In some cases, the unsupervised machine learning model is a pre-trained unsupervised machine learning model, pre-trained utilizing an unlabeled training-data set comprising of a plurality of unlabeled images.

In some cases, at least some of the unlabeled images are gathered randomly from publicly available images.

In some cases, the unlabeled images comprise of images of persons from a given region.

In some cases, the supervised machine learning model is trained utilizing a labeled training-data comprising of a plurality of records, each record comprising an embedding vector of a given image of a given person associated with a given transaction, and wherein at least some given records of the records are associated with a label indicative of a given risk score associated with the corresponding given transaction being performed for the given person.

In some cases, the supervised machine learning model is trained utilizing a labeled training-data comprising of a plurality of records, each record comprising: (i) an embedding vector of a given image of a given person associated with a given transaction, and (ii) one or more properties of the given transaction, and wherein at least some given records of the records are associated with a label indicative of a given risk score associated with the corresponding given transaction being performed for the given person.

In some cases, the supervised machine learning model is based on one or more neural network techniques.

In some cases, the person is one or more of: a male, or a female.

In accordance with a third aspect of the presently disclosed subject matter, there is provided a non-transitory computer readable storage medium having computer readable program code embodied therewith, the computer readable program code, executable by at least one processing circuitry of a computer to perform a method for determining a risk score associated with a transaction, the method comprising: obtaining, by a processing circuitry: (a) an unsupervised machine learning model capable of receiving an image of a person associated with the transaction and calculating an embedding vector for the image, (b) a supervised machine learning model capable of receiving an embedding vector of the image and determining the risk score associated with the transaction being performed for the person, and (c) the image of the person; calculating, by the processing circuitry, the embedding vector of the image by utilizing the image of the person and the unsupervised machine learning model; and determining, by the processing circuitry, the risk score associated with the transaction being performed for the person by utilizing the calculated embedding vector and the supervised machine learning model.

In accordance with a fourth aspect of the presently disclosed subject matter, there is provided a system for determining a risk score associated with a transaction, the system comprising a processing circuitry configured to: obtain: (a) a supervised machine learning model capable of receiving one or more facial features extracted from an image of a person associated with the transaction and determining the risk score associated with the transaction being performed for the person, and (b) the image of the person; and determine the risk score associated with the transaction being performed for the person by utilizing the facial features and the supervised machine learning model.

In some cases, the facial features include one or more of: facial landmarks features extracted from a face of the person appearing in the image, biological features extracted from a face of the person appearing in the image, genetic system features extracted from a face of the person appearing in the image, hormonal system features extracted from a face of the person appearing in the image, immune system features extracted from a face of the person appearing in the image, psychological features extracted from a face of the person appearing in the image, or emotional features extracted from a face of the person appearing in the image.

In some cases, at least one of the facial features is extracted from the image using a facial image feature extracting machine learning model.

In some cases, the image of the person is one of: (a) a static two-dimensional facial image of the person associated with the transaction, (b) a static three-dimensional facial image of the person associated with the transaction, (c) a static two-dimensional facial model of the person associated with the transaction, (d) a static three-dimensional facial model of the person associated with the transaction, (e) a two-dimensional static image of the person associated with the transaction, (f) a static three-dimensional image of the person associated with the transaction, (g) a moving image of the person associated with the transaction, (h) an analog video clip of the person associated with the transaction, and (i) a digital video clip of the person associated with the transaction.

In some cases, the at least one static three-dimensional facial image of the person associated with the transaction is generated from one or more of: (a) a hologram of the person associated with the transaction, and (b) a static two-dimensional image of the person associated with the transaction, and (c) a static three-dimensional image of the person associated with the transaction.

In some cases, the image is captured from one or more of: (a) a video recording of the person associated with the transaction, (b) a static two-dimensional image of the person associated with the transaction, or (c) a static three-dimensional image of the person associated with the transaction.

In some cases, (a) the processing circuitry is further configured to obtain one or more properties of the transaction being performed for the person, (b) the supervised machine learning model is also capable of receiving one or more properties of the transaction being performed for the person, and (c) the determination of the risk score associated with the transaction being performed for the person also utilizes the one or more properties of the transaction being performed for the person.

In some cases, (a) the transaction is a financial transaction for approving a financial service to the person, and (b) the properties of the financial transaction include one or more of: financial service starting date, financial service ending date, financial service currency, financial service amount, financial service interest rate, or number of installments for the financial service.

In some cases, (a) the transaction is an insurance transaction for approving an insurance policy to the person, and (b) the properties of the insurance transaction include one or more of: insurance policy amount, insurance policy currency, insurance policy starting date, insurance policy ending date, insurance policy premium, or insurance policy number of installments.

In some cases, (a) the transaction is a security transaction for clearance for the person, and (b) the properties of the security transaction include one or more of: transaction date, existing levels of security clearance for the person, level of clearance requested for the person, historical travel information for the person, family members information for the person, friends information for the person, historical publications of the person, historical security information for the person, or counter-security activities of the person.

In some cases, (a) the transaction is a human resource transaction for recruitment of the person into a team, and (b) the properties of the human resource transaction include one or more of: team size, images of the team members, team task, professions of the team members, or gender of the team members.

In some cases, (a) the processing circuitry is further configured to obtain additional features extracted from the image of the person associated with the transaction, (b) the supervised machine learning model is also capable of receiving the additional features, and (c) the determination of the risk score associated with the transaction being performed for the person also utilizes the additional features.

In some cases, the additional features include one or more of: garments features of at least part of garments worn by the person appearing in the image, body-part features of at least part of a body of the person appearing in the image, palm features of at least part of a palm of the person appearing in the image, or background features extracted from a background of the image.

In some cases, at least one of the additional features is extracted from the image using an image feature extracting machine learning model.

In some cases, the supervised machine learning model is trained utilizing a labeled training-data comprising of a plurality of records, each record comprising one or more facial features extracted from a given image of a given person associated with a given transaction, and wherein at least some given records of the records are associated with a label indicative of a given risk score associated with the corresponding given transaction being performed for the given person.

In some cases, the supervised machine learning model is trained utilizing a labeled training-data comprising of a plurality of records, each record comprising: (i) one or more facial features extracted from a given image of a given person associated with a given transaction, and (ii) properties of the given transaction, and wherein at least some given records of the records are associated with a label indicative of a given risk score associated with the corresponding given transaction being performed for the given person.

In some cases, the supervised machine learning model is based on one or more neural network techniques.

In some cases, the person is one or more of: a male, or a female.

In accordance with a fifth aspect of the presently disclosed subject matter, there is provided a method for determining a risk score associated with a transaction, the method comprising: obtaining, by a processing circuitry: (a) a supervised machine learning model capable of receiving one or more facial features extracted from an image of a person associated with the transaction and determining the risk score associated with the transaction being performed for the person, and (b) the image of the person; and determining, by the processing circuitry, the risk score associated with the transaction being performed for the person by utilizing the facial features and the supervised machine learning model.

In some cases, the facial features include one or more of: facial landmarks features extracted from a face of the person appearing in the image, biological features extracted from a face of the person appearing in the image, genetic system features extracted from a face of the person appearing in the image, hormonal system features extracted from a face of the person appearing in the image, immune system features extracted from a face of the person appearing in the image, psychological features extracted from a face of the person appearing in the image, or emotional features extracted from a face of the person appearing in the image.

In some cases, at least one of the facial features is extracted from the image using a facial image feature extracting machine learning model.

In some cases, the image of the person is one of: (a) a static two-dimensional facial image of the person associated with the transaction, (b) a static three-dimensional facial image of the person associated with the transaction, (c) a static two-dimensional facial model of the person associated with the transaction, (d) a static three-dimensional facial model of the person associated with the transaction, (e) a two-dimensional static image of the person associated with the transaction, (f) a static three-dimensional image of the person associated with the transaction, (g) a moving image of the person associated with the transaction, (h) an analog video clip of the person associated with the transaction, and (i) a digital video clip of the person associated with the transaction.

In some cases, the at least one static three-dimensional facial image of the person associated with the transaction is generated from one or more of: (a) a hologram of the person associated with the transaction, and (b) a static two-dimensional image of the person associated with the transaction, and (c) a static three-dimensional image of the person associated with the transaction.

In some cases, the image is captured from one or more of: (a) a video recording of the person associated with the transaction, (b) a static two-dimensional image of the person associated with the transaction, or (c) a static three-dimensional image of the person associated with the transaction.

In some cases, (a) the processing circuitry is further configured to obtain one or more properties of the transaction being performed for the person, (b) the supervised machine learning model is also capable of receiving one or more properties of the transaction being performed for the person, and (c) the determination of the risk score associated with the transaction being performed for the person also utilizes the one or more properties of the transaction being performed for the person.

In some cases, (a) the transaction is a financial transaction for approving a financial service to the person, and (b) the properties of the financial transaction include one or more of: financial service starting date, financial service ending date, financial service currency, financial service amount, financial service interest rate, or number of installments for the financial service.

In some cases, (a) the transaction is an insurance transaction for approving an insurance policy to the person, and (b) the properties of the insurance transaction include one or more of: insurance policy amount, insurance policy currency, insurance policy starting date, insurance policy ending date, insurance policy premium, or insurance policy number of installments.

In some cases, (a) the transaction is a security transaction for clearance for the person, and (b) the properties of the security transaction include one or more of: transaction date, existing levels of security clearance for the person, level of clearance requested for the person, historical travel information for the person, family members information for the person, friends information for the person, historical publications of the person, historical security information for the person, or counter-security activities of the person.

In some cases, (a) the transaction is a human resource transaction for recruitment of the person into a team, and (b) the properties of the human resource transaction include one or more of: team size, images of the team members, team task, professions of the team members, or gender of the team members.

In some cases, (a) the processing circuitry is further configured to obtain additional features extracted from the image of the person associated with the transaction, (b) the supervised machine learning model is also capable of receiving the additional features, and (c) the determination of the risk score associated with the transaction being performed for the person also utilizes the additional features.

In some cases, the additional features include one or more of: garments features of at least part of garments worn by the person appearing in the image, body-part features of at least part of a body of the person appearing in the image, palm features of at least part of a palm of the person appearing in the image, or background features extracted from a background of the image.

In some cases, at least one of the additional features is extracted from the image using an image feature extracting machine learning model.

In some cases, the supervised machine learning model is trained utilizing a labeled training-data comprising of a plurality of records, each record comprising one or more facial features extracted from a given image of a given person associated with a given transaction, and wherein at least some given records of the records are associated with a label indicative of a given risk score associated with the corresponding given transaction being performed for the given person.

In some cases, the supervised machine learning model is trained utilizing a labeled training-data comprising of a plurality of records, each record comprising: (i) one or more facial features extracted from a given image of a given person associated with a given transaction, and (ii) properties of the given transaction, and wherein at least some given records of the records are associated with a label indicative of a given risk score associated with the corresponding given transaction being performed for the given person.

In some cases, the supervised machine learning model is based on one or more neural network techniques.

In some cases, the person is one or more of: a male, or a female.

In accordance with a sixth aspect of the presently disclosed subject matter, there is provided anon-transitory computer readable storage medium having computer readable program code embodied therewith, the computer readable program code, executable by at least one processing circuitry of a computer to perform a method for determining a risk score associated with a transaction, the method comprising: obtaining, by a processing circuitry: (a) a supervised machine learning model capable of receiving one or more facial features extracted from an image of a person associated with the transaction and determining the risk score associated with the transaction being performed for the person, and (b) the image of the person; and determining, by the processing circuitry, the risk score associated with the transaction being performed for the person by utilizing the facial features and the supervised machine learning model.

In accordance with a seventh aspect of the presently disclosed subject matter, there is provided a system for determining a risk score associated with a transaction, the system comprising a processing circuitry configured to: obtain: (a) a transfer-learning machine learning model capable of receiving an image of a person associated with the transaction and determining the risk score associated with the transaction being performed for the person, and (b) the image of the person; and determine the risk score associated with the transaction being performed for the person by utilizing the image of the person, and the transfer-learning machine learning model.

In some cases, the transfer-learning machine learning model is trained utilizing supervised training performed on a pre-trained unsupervised machine learning model having an input layer, an output layer and multiple intermediate layers, each intermediate layer comprising nodes with weights, wherein the supervised training is performed while freezing the weights of at least one layer of the layers.

In some cases, the one or more frozen layers are intermediate layers preceding the output layer of the pre-trained unsupervised machine learning model.

In some cases, the pre-trained unsupervised machine learning model is pre-trained utilizing an unlabeled training-data set comprising of a plurality of unlabeled images.

In some cases, at least some of the unlabeled images are gathered randomly from publicly available images.

In some cases, the unlabeled images comprise of images of persons from a given region.

In some cases, the image of the person is one of: (a) a static two-dimensional facial image of the person associated with the transaction, (b) a static three-dimensional facial image of the person associated with the transaction, (c) a static two-dimensional facial model of the person associated with the transaction, (d) a static three-dimensional facial model of the person associated with the transaction, (e) a two-dimensional static image of the person associated with the transaction, (f) a static three-dimensional image of the person associated with the transaction, (g) a moving image of the person associated with the transaction, (h) an analog video clip of the person associated with the transaction, and (i) a digital video clip of the person associated with the transaction.

In some cases, the at least one static three-dimensional facial image of the person associated with the transaction is generated from one or more of: (a) a hologram of the person associated with the transaction, and (b) a static two-dimensional image of the person associated with the transaction, and (c) a static three-dimensional image of the person associated with the transaction.

In some cases, the image is captured from one or more of: (a) a video recording of the person associated with the transaction, (b) a static two-dimensional image of the person associated with the transaction, or (c) a static three-dimensional image of the person associated with the transaction.

In some cases, (a) the processing circuitry is further configured to obtain one or more properties of the transaction being performed for the person, (b) the transfer-learning machine learning model is also capable of receiving one or more properties of the transaction being performed for the person, and (c) the determination of the risk score associated with the transaction being performed for the person also utilizes the one or more properties of the transaction being performed for the person.

In some cases, (a) the transaction is a financial transaction for approving a financial service to the person, and (b) the properties of the financial transaction include one or more of: financial service starting date, financial service ending date, financial service currency, financial service amount, financial service interest rate, or number of installments for the financial service.

In some cases, (a) the transaction is an insurance transaction for approving an insurance policy to the person, and (b) the properties of the insurance transaction include one or more of: insurance policy amount, insurance policy currency, insurance policy starting date, insurance policy ending date, insurance policy premium, or insurance policy number of installments.

In some cases, (a) the transaction is a security transaction for clearance for the person, and (b) the properties of the security transaction include one or more of: transaction date, existing levels of security clearance for the person, level of clearance requested for the person, historical travel information for the person, family members information for the person, friends information for the person, historical publications of the person, historical security information for the person, or counter-security activities of the person.

In some cases, (a) the transaction is a human resource transaction for recruitment of the person into a team, and (b) the properties of the human resource transaction include one or more of: team size, images of the team members, team task, professions of the team members, or gender of the team members.

In some cases, (a) the processing circuitry is further configured to obtain facial features extracted from the image of the person associated with the transaction, (b) the transfer-learning machine learning model is also capable of receiving the facial features, and (c) the determination of the risk score associated with the transaction being performed for the person also utilizes the facial features.

In some cases, the facial features include one or more of: facial landmarks features extracted from a face of the person appearing in the image, biological features of the person appearing in the image, genetic system features of the person appearing in the image, hormonal system features of the person appearing in the image, immune system features of the person appearing in the image, psychological features of the person appearing in the image, or emotional features of the person appearing in the image.

In some cases, at least one of the facial features is extracted from the image using a facial image feature extracting machine learning model.

In some cases, (a) the processing circuitry is further configured to obtain additional features extracted from the image of the person associated with the transaction, (b) the transfer-learning machine learning model is also capable of receiving the additional features, and (c) the determination of the risk score associated with the transaction being performed for the person also utilizes the additional features.

In some cases, the additional features include one or more of: garments features of at least part of garments worn by the person appearing in the image, body-part features of at least part of a body of the person appearing in the image, palm features of at least part of a palm of the person appearing in the image, or background features extracted from a background of the image.

In some cases, at least one of the additional features is extracted from the image using an image feature extracting machine leaning model.

In some cases, the transfer-learning machine learning model is trained utilizing a labeled training-data comprising of a plurality of records, each record comprising: a given image of a given person associated with a given transaction, and wherein at least some given records of the records are associated with a label indicative of a given risk score associated with the corresponding given transaction being performed for the given person.

In some cases, the transfer-learning machine learning model is trained utilizing a labeled training-data comprising of a plurality of records, each record comprising: (i) a given image of a given person associated with a given transaction, and (ii) properties of the given transaction, and wherein at least some given records of the records are associated with a label indicative of a given risk score associated with the corresponding given transaction being performed for the given person.

In some cases, the transfer-learning machine learning model is based on one or more neural network techniques.

In some cases, the person is one or more of: a male, or a female.

In accordance with an eighth aspect of the presently disclosed subject matter, there is provided a method for determining a risk score associated with a transaction, the method comprising: obtaining, by a processing circuitry: (a) a transfer-learning machine learning model capable of receiving an image of a person associated with the transaction and determining the risk score associated with the transaction being performed for the person, and (b) the image of the person; and determining, by the processing circuitry, the risk score associated with the transaction being performed for the person by utilizing the image of the person, and the transfer-learning machine learning model.

In some cases, the transfer-learning machine learning model is trained utilizing supervised training performed on a pre-trained unsupervised machine learning model having an input layer, an output layer and multiple intermediate layers, each intermediate layer comprising nodes with weights, wherein the supervised training is performed while freezing the weights of at least one layer of the layers.

In some cases, the one or more frozen layers are intermediate layers preceding the output layer of the pre-trained unsupervised machine learning model.

In some cases, the pre-trained unsupervised machine learning model is pre-trained utilizing an unlabeled training-data set comprising of a plurality of unlabeled images.

In some cases, at least some of the unlabeled images are gathered randomly from publicly available images.

In some cases, the unlabeled images comprise of images of persons from a given region.

In some cases, the image of the person is one of: (a) a static two-dimensional facial image of the person associated with the transaction, (b) a static three-dimensional facial image of the person associated with the transaction, (c) a static two-dimensional facial model of the person associated with the transaction, (d) a static three-dimensional facial model of the person associated with the transaction, (e) a two-dimensional static image of the person associated with the transaction, (f) a static three-dimensional image of the person associated with the transaction, (g) a moving image of the person associated with the transaction, (h) an analog video clip of the person associated with the transaction, and (i) a digital video clip of the person associated with the transaction.

In some cases, the at least one static three-dimensional facial image of the person associated with the transaction is generated from one or more of: (a) a hologram of the person associated with the transaction, and (b) a static two-dimensional image of the person associated with the transaction, and (c) a static three-dimensional image of the person associated with the transaction.

In some cases, the image is captured from one or more of: (a) a video recording of the person associated with the transaction, (b) a static two-dimensional image of the person associated with the transaction, or (c) a static three-dimensional image of the person associated with the transaction.

In some cases, (a) the processing circuitry is further configured to obtain one or more properties of the transaction being performed for the person, (b) the transfer-learning machine learning model is also capable of receiving one or more properties of the transaction being performed for the person, and (c) the determination of the risk score associated with the transaction being performed for the person also utilizes the one or more properties of the transaction being performed for the person.

In some cases, (a) the transaction is a financial transaction for approving a financial service to the person, and (b) the properties of the financial transaction include one or more of: financial service starting date, financial service ending date, financial service currency, financial service amount, financial service interest rate, or number of installments for the financial service.

In some cases, (a) the transaction is an insurance transaction for approving an insurance policy to the person, and (b) the properties of the insurance transaction include one or more of: insurance policy amount, insurance policy currency, insurance policy starting date, insurance policy ending date, insurance policy premium, or insurance policy number of installments.

In some cases, (a) the transaction is a security transaction for clearance for the person, and (b) the properties of the security transaction include one or more of: transaction date, existing levels of security clearance for the person, level of clearance requested for the person, historical travel information for the person, family members information for the person, friends information for the person, historical publications of the person, historical security information for the person, or counter-security activities of the person.

In some cases, (a) the transaction is a human resource transaction for recruitment of the person into a team, and (b) the properties of the human resource transaction include one or more of: team size, images of the team members, team task, professions of the team members, or gender of the team members.

In some cases, (a) the processing circuitry is further configured to obtain facial features extracted from the image of the person associated with the transaction, (b) the transfer-learning machine learning model is also capable of receiving the facial features, and (c) the determination of the risk score associated with the transaction being performed for the person also utilizes the facial features.

In some cases, the facial features include one or more of: facial landmarks features extracted from a face of the person appearing in the image, biological features of the person appearing in the image, genetic system features of the person appearing in the image, hormonal system features of the person appearing in the image, immune system features of the person appearing in the image, psychological features of the person appearing in the image, or emotional features of the person appearing in the image.

In some cases, at least one of the facial features is extracted from the image using a facial image feature extracting machine learning model.

In some cases, (a) the processing circuitry is further configured to obtain additional features extracted from the image of the person associated with the transaction, (b) the transfer-learning machine learning model is also capable of receiving the additional features, and (c) the determination of the risk score associated with the transaction being performed for the person also utilizes the additional features.

In some cases, the additional features include one or more of: garments features of at least part of garments worn by the person appearing in the image, body-part features of at least part of a body of the person appearing in the image, palm features of at least part of a palm of the person appearing in the image, or background features extracted from a background of the image.

In some cases, at least one of the additional features is extracted from the image using an image feature extracting machine leaning model.

In some cases, the transfer-learning machine learning model is trained utilizing a labeled training-data comprising of a plurality of records, each record comprising: a given image of a given person associated with a given transaction, and wherein at least some given records of the records are associated with a label indicative of a given risk score associated with the corresponding given transaction being performed for the given person.

In some cases, the transfer-learning machine learning model is trained utilizing a labeled training-data comprising of a plurality of records, each record comprising: (i) a given image of a given person associated with a given transaction, and (ii) properties of the given transaction, and wherein at least some given records of the records are associated with a label indicative of a given risk score associated with the corresponding given transaction being performed for the given person.

In some cases, the transfer-learning machine learning model is based on one or more neural network techniques.

In some cases, the person is one or more of: a male, or a female.

In accordance with a ninth aspect of the presently disclosed subject matter, there is provided a non-transitory computer readable storage medium having computer readable program code embodied therewith, the computer readable program code, executable by at least one processing circuitry of a computer to perform a method for determining a risk score associated with a transaction, the method comprising: obtaining, by a processing circuitry: (a) a transfer-learning machine learning model capable of receiving an image of a person associated with the transaction and determining the risk score associated with the transaction being performed for the person, and (b) the image of the person; and determining, by the processing circuitry, the risk score associated with the transaction being performed for the person by utilizing the image of the person, and the transfer-learning machine learning model.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1A is a schematic illustration of a first possible embodiment of a risk determination architecture, in accordance with the presently disclosed subject matter;

FIG. 1B is a schematic illustration of a second possible embodiment of the risk determination architecture, in accordance with the presently disclosed subject matter;

FIG. 1C is a schematic illustration of a third possible embodiment of the risk determination architecture, in accordance with the presently disclosed subject matter;

FIG. 2 is a block diagram schematically illustrating one example of a risk determination system, in accordance with the presently disclosed subject matter;

FIG. 3 is a flowchart illustrating an example of a sequence of operations carried out by a first embodiment of the risk determination system, in accordance with the presently disclosed subject matter;

FIG. 4 is a flowchart illustrating an example of a sequence of operations carried out by a second embodiment of the risk determination system, in accordance with the presently disclosed subject matter; and

FIG. 5 is a flowchart illustrating an example of a sequence of operations carried out by a third embodiment of the risk determination system, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “identifying”, “calculating”, “generating”, “determining” or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

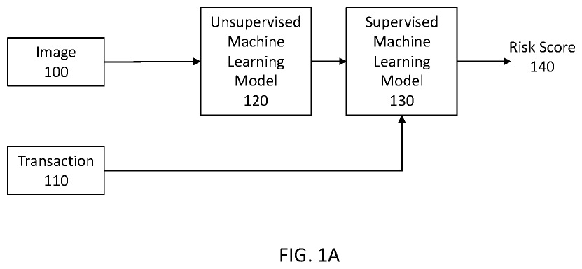

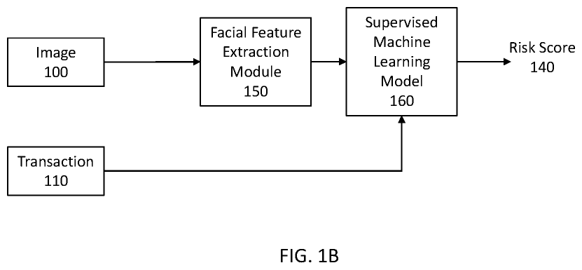

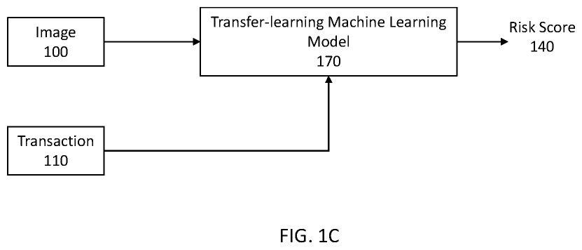

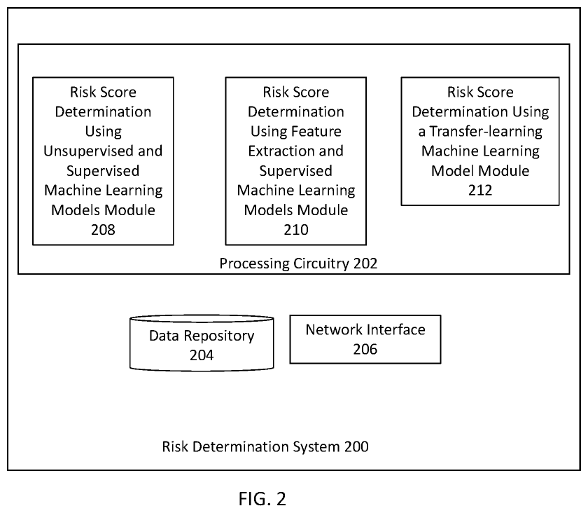

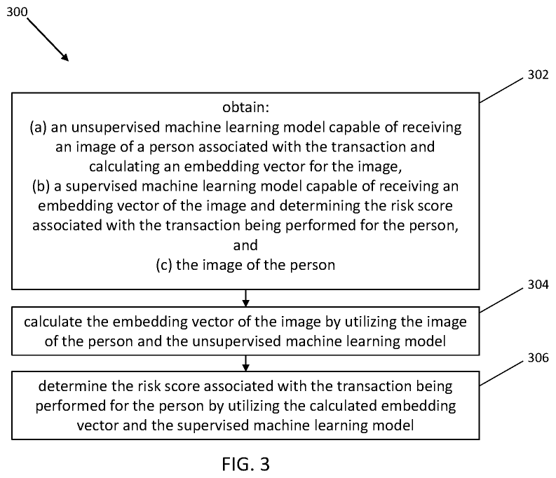

In embodiments of the presently disclosed subject matter, fewer, more and/or different stages than those shown in FIGS. 3-5 may be executed. In embodiments of the presently disclosed subject matter one or more stages illustrated in FIGS. 3-5 may be executed in a different order and/or one or more groups of stages may be executed simultaneously. FIGS. 1A, 1B, 1C and 2 illustrate a general schematic of the system architecture in accordance with an embodiment of the presently disclosed subject matter. Each module in FIGS. 1A, 1B, 1C and 2 can be made up of any combination of software, hardware and/or firmware that performs the functions as defined and explained herein. The modules in FIGS. 1A, 1B, 1C and 2 may be centralized in one location or dispersed over more than one location. In other embodiments of the presently disclosed subject matter, the system may comprise fewer, more, and/or different modules than those shown in FIGS. 1A, 1B, 1C and 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Service providers (such as: financial institutions, insurance providers, security providers and Human Resource (HR) service providers—that can be either internal or external to an organization, or any other service providing institutions)—utilize a risk score determination system to evaluate and/or assess and/or determine risk (to the service provider) associated with a transaction including the user(s) involved. The risk can be a risk score (for example: a number on a scale from 0 to 100 where 100 is the highest risk score), a binary risk indication (for example: 0 indicating that no risk is associated with the transaction and 1 for indication of risk associated with the transaction), a risk level (for example: “High”, “Medium” and “Low” risk levels) or any other way to indicate risk associated with the transaction. The transaction can be any operation performed by the service provider to evaluate and/or approve a service to an entity (such as: a person). A non-limiting example of a transaction is a financial transaction performed by a financial service provider to evaluate and/or approve a financial service to an entity (such as: a person), such as a loan or credit or any other financial service provided by the financial service provider to the entity. In the case of a loan, the risk associated with the transaction can be the risk of that entity defaulting (i.e., not paying the loan, fully or partially, and/or not paying the loan on time, fully or partially, and/or any other form of default) on the loan. Another non-limiting example is of an insurance transaction, wherein an insurance provider can utilize the risk score determination system to evaluate and/or assess and/or determine risk associated with an insurance transaction. For example: for evaluating and/or approving an insurance policy to an entity (such as: a person). In the case of an insurance policy, the risk associated with the insurance transaction can be the probability of occurrence of the risks and/or perils that have the potential to cause financial loss or bodily injury or health diseases that are covered by the insurance policy. An additional non-limiting example is of a transaction that is a security transaction. The security transaction can be performed by a security service provider that can be internal or external to a recipient organization that receives the service. The security service provider can utilize the risk score determination system to evaluate and/or assess and/or determine risk associated with a security transaction. For example: for evaluating and/or approving a clearance and/or any other security related transaction for an entity (such as: a person). In the case of clearance of a person the risks associated with the security transactions are associated with the prospect of a security breach realized by that person. Another non-limiting example of a transaction is an HR transaction performed by an HR service provider, that can be internal or external to a recipient organization, to evaluate the reliability of a person who is a candidate to a given role and/or to a given team. The risk associated with such an HR transaction is the risk of the person being unreliable in the context of the given role and/or the given team.

Determining risk associated with a transaction is a challenging task. One possibility is utilizing findings from the domain of psychology. Evolutionary psychology research has found a correlation between a person's physical properties and character that leads to his/her choices and actions. Physiology studies suggest that biological properties of an individual have major influence on that individual's behavioral probabilities. This is why physiological properties can be utilized as a measure of risk of a transaction based on an image (such as: a facial image) of a person associated with the transaction, without the need to gather large amounts of information about that person. Other domains can offer additional correlations between personal properties and risk measurements, for example: correlation between the level of certain neurotransmitters in a given person and the risk associated with the personality and behavioral traits of that person.

It is to be noted that risk determination of a person having no prior known transactions is predicted to be an even more challenging task as more and more aspects of our lives are experienced on-line by anonymous users for which the service provider has no or little prior knowledge. The unbanked and underbanked populations in developing and emerging countries are an example of such a need to provide financial and insurance services to people that are almost unknown to the service providers, in terms of historical transactions and/or credit scores. In such cases, the need for the described solution will only become more acute.

Bearing this in mind, attention is drawn to FIG. 1A, showing a schematic illustration of a first possible embodiment of a risk determination architecture, in accordance with the presently disclosed subject matter.

As shown in the schematic illustration, a risk determination system can be devised in accordance with the first possible embodiment of the risk determination architecture. The first possible embodiment of the risk determination architecture comprises at least one image 100, which is associated with transaction 110. Image 100 can be an image of a person (the person can be, for example, a male, a female and/or of any other gender) associated with the transaction 110. The image 100 can incorporate one or more facial images that can be used to train the facial features of the person. Image 100 can include at least one facial image of the person. Facial structures can be utilized to determine risk associated with the transaction 110. Transaction 110 can be a financial transaction, an insurance transaction, a security transaction, an HR transaction or any other transaction provided by a service provider. The transaction 110 can be associated with the person. For example: a loan to the person, an insurance policy for the person, security clearance of the person, recruitment of the person to a given role or to a given team, or any other transaction that can be associated with the person and/or performed for the person. Transaction 110 can have one or more properties associated with the transaction 110. The properties can include for example for a transaction 110 that is a financial transaction for evaluating and/or approving and/or providing a financial service: financial service starting date, financial service ending date, financial service currency, financial service amount, financial service interest rate, number of installments for the financial service or any other property of the financial transaction. In other cases, the properties can include for example for a transaction 110 that is an insurance transaction for evaluating and/or approving and/or providing an insurance policy to the person: insurance policy amount, insurance policy currency, insurance policy starting date, insurance policy ending date, insurance policy premium, insurance policy number of installments or any other property of the insurance transaction. The properties can also include for example for a transaction 110 that is a security transaction for evaluating and/or approving and/or clearing the person and/or providing any other security-related transaction: transaction date, existing levels of security clearance for the person, level of clearance requested for the person, historical travel information for the person, family members information for the person, friends information for the person, historical publications of the person, historical security information for the person, or counter-security activities of the person or any other property of the security transaction. In some cases, the properties can include for example for a transaction 110 that is an HR transaction for evaluating and/or approving recruitment and/or assignment of the person: team size, images of the team members, team task, professions of the team members, gender of the team members or any other property of the HR transaction.

The first embodiment of the risk determination architecture further comprises an unsupervised machine learning model 120. The unsupervised machine learning model 120 is capable of receiving image 100. Image 100 can be an image of a person associated with the transaction 110. Unsupervised machine learning model 120 is capable of calculating and/or extracting an embedding vector from the image 100. An embedding vector is a numerical vector that represents the data inputted into the supervised machine learning model 130, in this case the embedding vector is an ordered list of numbers representing the image 100. In some cases, the unsupervised machine learning model 120 is comprised of two or more sub models—each generating one or more sub-embedding vectors and where the output of the unsupervised machine learning model 120 can be based on the sub-embedding vectors, for example: by concatenation the sub-embedding vectors into one embedding vector. The embedding vector can be used as input to a supervised machine learning model 130, as further explained below.

Unsupervised machine learning model 120 can be a pre-trained unsupervised machine learning model, pre-trained utilizing a training-data set comprising of a plurality of images. The training-data set can be an unlabeled training-data set comprising of a plurality of unlabeled images. In some cases, at least some of the unlabeled images are gathered randomly from publicly available images, for example: the images can be gathered from the Internet. In some cases, the unlabeled images comprise of images of persons from a given region—a country or part of it, a continent of part of it or from any other region (for example: images of persons from Asia, images of persons from Brazil, etc.). In these cases, the unsupervised machine learning model 120 is trained with the unlabeled training set, such that the weights determined during the training for the pre-trained model are modified to reflect users from that specific region. This kind of training can be used to create a risk determination architecture that is tailored for service providers serving people from a specific region. In some cases, unsupervised machine learning model 120 can be based on a transformer machine learning architecture as known in the art, such as: Generative Pre-trained Transformer (GPT), Bidirectional Encoder Representations from Transformer (BERT) or other transformer-based machine learning models.

Unsupervised machine learning model 120 can be, for a non-limiting example, a FaceNet machine learning model which is a unified embedding for face recognition and clustering that directly learns a mapping from face images to a compact Euclidean space where distances directly correspond to a measure of face similarity. The FaceNet model can be pre-trained over images of human faces. The FaceNet machine learning model can generate embedding vectors of ordered multiple values. In the first embodiment of the risk determination architecture all or part of the multiple values that represent the image in the vector embedding can be used as the output of the unsupervised machine learning model 120. It is to be noted that other machine learning models can be used in a similar way to the FaceNet model, such as: DeepFace, ArcFace, OpenFace, Dlib or any other solution that can extract an embedding vector from an image. Another non-limiting example of the unsupervised machine learning model 120 is comprised of two or more sub-models—that work on the same image to extract an integrated embedding vector that is based on the embedding vectors extracted by one or more of the sub-models.

The first embodiment of the risk determination architecture further comprises a supervised machine learning model 130, capable of receiving the embedding vector output of the unsupervised machine learning model 120 and determining a risk score 140, being the risk associated with the transaction 110 that is being performed for the person imaged in image 100. Risk score 140 can be for example: a number on a scale from 0 to 100 where 100 is the highest risk score, and/or a binary risk indication (for example: 0 indicating that no risk is associated with the transaction 110 and 1 for indication that there is a risk associated with the transaction 110), and/or a risk level (for example: “High”, “Medium” and “Low” risk levels) and/or any other way to indicate risk associated with the transaction 110.

The supervised machine learning model 130 can be trained utilizing a labeled training-data set comprising of a plurality of records, each record comprising an embedding vector of a given image 100 of a given person associated with a given transaction 110, and wherein at least some given records of the records are associated with a label indicative of a given risk score 140 associated with the corresponding given transaction 110 being performed for the given person. The supervised machine learning model 130 is trained to learn the correlation between the embedding vector and the risk score 140, such that after training is complete, the supervised machine learning model 130 can receive a given un-labeled embedding vector and can predict the risk score 140 for that given embedding vector.

The supervised machine learning model 130 can be based on one or more deep learning and/or artificial neural network (ANN) techniques, for example: Convolutional Neural Networks (CNN), Deep Stacking Networks (DSN), Graph Neural Network (GNN), machine learning techniques such as Support Vector Machine (SVM), eXtreme Gradient Boosting (XGBoost), Light Gradient Boosting Machine (LGBM), etc.

Optionally, the supervised machine learning model 130 can also receive one or more properties of the transaction 110 being performed for the person. In these cases, the supervised machine learning model 130 is capable of determining the risk score 140 associated with the transaction being performed for the person based on the embedding vector and also based on the one or more properties of the transaction being performed for the person. In these cases, the supervised machine learning model 130 is trained utilizing a labeled training-data comprising of a plurality of records, where each record comprising: an embedding vector of a given image 100 of a given person associated with a given transaction 110, and the one or more properties of the given transaction 110, and wherein at least some given records of the records are associated with a label indicative of a given risk score associated with the corresponding given transaction being performed for the given person. In these cases, the supervised machine learning model 130 is trained to learn the correlation between the embedding vector and the properties of the given transaction 110 and the risk score 140, such that after training is complete, the supervised machine learning model 130 can receive a given un-labeled embedding vector and properties of the given transaction 110 and predict the risk score 140 for that given embedding vector associated with the given transaction 110.

Optionally, the supervised machine learning model 130 can also receive one or more facial features extracted from the image 100 of the person associated with the transaction 110. It is notable that face structure (and features) is unique. Each individual has its personality manifested in his or her own face structure (and features). Human faces have evolved to signal and/or reflect individual identity in human interaction. Facial structure (and features) can be utilized to determine risks. The structure of the face reflects the genetic characteristics of that individual. Facial structure exposes the individual's health, parental suitability, level of aggressiveness, and more.

In these cases, the supervised machine learning model 130 is capable of determining the risk score 140 associated with the transaction being performed for the person based on the embedding vector and also based on the one or more facial features. In these cases, the supervised machine learning model 130 is trained utilizing a labeled training-data comprising of a plurality of records, where each record comprising: an embedding vector of a given image 100 of a given person associated with a given transaction 110, and the one or more facial features of a face of the person appearing in given image 100, and wherein at least some given records of the records are associated with a label indicative of a given risk score associated with the corresponding given transaction being performed for the given person. In these cases, the supervised machine learning model 130 is trained to learn the correlation between the embedding vector and the facial features and the risk score 140, such that after training is complete, the supervised machine learning model 130 can receive a given un-labeled embedding vector and facial features of the face of the person appearing in given image 100 and predict the risk score 140 for that given embedding vector associated with the given transaction 110. It is to be noted that the facial features can include one or more of: facial landmarks-based features extracted from a face of the person appearing in the image 100, biological features of the person appearing in the image 100, genetic system features of the person appearing in the image 100, hormonal system features of the person appearing in the image 100, immune system features of the person appearing in the image 100, psychological features of the person appearing in the image 100, emotional features of the person appearing in the image 100, and/or any other facial features of the person appearing in the image 100. At least one of the facial features can be extracted from the image 100 using a facial image feature extracting machine learning model.

Optionally, the supervised machine learning model 130 can also receive one or more additional features extracted from the image 100 of the person associated with the transaction 110. In these cases, the supervised machine learning model 130 is capable of determining the risk score 140 associated with the transaction being performed for the person based on the embedding vector and also based on the one or more additional features. In these cases, the supervised machine learning model 130 is trained utilizing a labeled training-data comprising of a plurality of records, where each record comprising: an embedding vector of a given image 100 of a given person associated with a given transaction 110, and the one or more additional features of the person appearing in given image 100, and wherein at least some given records of the records are associated with a label indicative of a given risk score associated with the corresponding given transaction being performed for the given person. In these cases, the supervised machine learning model 130 is trained to learn the correlation between the embedding vector and the additional features and the risk score 140, such that after training is complete, the supervised machine learning model 130 can receive a given un-labeled embedding vector and additional features of the person appearing in given image 100 and predict the risk score 140 for that given embedding vector associated with the given transaction 110. It is to be noted that the additional features can include one or more of: garments-based features of at least part of garments worn by the person appearing in the image 100, body-part features of at least part of a body of the person appearing in the image 100, palm-based features of at least part of a palm of the person appearing in the image 100, background features extracted from a background of the image 100, and/or any other additional features associated with image 100. At least one of the additional features can be extracted from the image 100 using an image feature extracting machine learning model.

It is to be noted that image 100 does not necessarily include faces. The risk determination system can utilize other parts of the images to determine the risk score 140 associated with transaction 110. For example, the risk determination system can utilize the backgrounds of the images 100, the travel landscapes of the images 100, the selfie angle of the images 100, clothing of the person in image 100, their accessories, etc., to determine risk score 140.

Another possibility is for the risk determination system to utilize images of at least part of a body of the captured persons (such as: the palm of the person) to determine the risk score 140. For example, by determining a finger feature (based on an index to ring ratio) for the image 100. Garments captured within the image can be also utilized by the system to determine the risk score 140.

In some cases, the risk determination system can be provided with multiple images 100 of the same person that is associated with transaction 110 (for example, when the person changes his/her selfie image for social purposes). The additional images 100 can be identical to the previous image 100 provided in the past for that person, or they can be new images 100, taken ad-hoc. The risk determination system can utilize all the multiple images 100 of the same person, available at a data repository used by the system to store the images 100 provided by the person in the current transaction 110 and other images 100 provided by the same person in prior transactions 110. Since all the images 100 relate to a specific person, they are all utilized to enhance the predicted risk score 140 —each image 100 according to the quality of the image 100 and its underlying face.

The pre-processing stage can include one or more image manipulations on at least one of the images 100. These manipulations can include: emotion removal (neutralization), facial image capturing angle adjustments, facial image size corrections, in-plane facial image rotation, out-of-plane facial image rotation (frontalization) and more. The risk determination system will use the manipulated images 100 to determine risk level 110.

The risk determination system can work in a batch mode—where multiple images 100 are provided to the system and the system determines the risk associated with transactions 110 performed for the persons captured in each image 100. In some cases, one or more video feeds are provided to the risk determination system, and the system extracts the images 100 from the video clips. For example, by capturing an image 100 from the video feed, or by analyzing the video clip to identify one or more persons and extracting their facial images 100 from the video.

A non-limiting example of a risk score determination system based on the first embodiment of the risk determination architecture comprises of: an unsupervised machine learning model 120 that has been pre-trained on facial images, a supervised machine learning model 130 that has been trained on labeled data of embedding vectors of images 100 of persons associated with transaction 110 and optionally on properties of transaction 110 facial features, and on additional features. This exemplary risk score determination system can receive a given image 100 associated with a new transaction 110, for which risk score 140 needs to be determined. This exemplary risk score determination system utilizes the unsupervised machine learning model 120 to determine a given embedding vector for the given image 100. This exemplary risk score determination system than utilizes the supervised machine learning model 130 with the given embedding vector as input, and optionally with properties of the new transaction 110 as additional input to determine the risk score 140 of the new transaction 110. Optionally, facial features and additional features can be provided to this exemplary risk score determination system, for example, by extracting them from image 100 to be used in the determination of the risk score 140.

The risk determination system can utilize these models: the unsupervised machine learning model 120 and the supervised machine learning model 130 to determine the risk score 140 associated with a transaction 110 based on the image 100 that is associated with the transaction 110, as will be further described hereafter in reference to FIG. 3.

Attention is now drawn to FIG. 1B, a schematic illustration of a second possible embodiment of the risk determination architecture, in accordance with the presently disclosed subject matter.

As shown in the schematic illustration, a risk determination system can be devised in accordance with the second possible embodiment of the risk determination architecture. The second possible embodiment of the risk determination architecture comprises at least one image 100 which is associated with transaction 110, in the manner described above in relation to FIG. 1A. The second possible embodiment of the risk determination architecture comprises a facial feature extraction module 150. The facial feature extraction module 150 can extract one or more facial features from image 100. The facial feature extraction module 150 can determine, for the image 100, one or more landmarks. Each landmark is a predetermined point within a facial image included in the image 100. The landmarks can be anatomical landmarks that are based on the anatomical structure of the face appearing within the image 100. These landmarks are unambiguously identified in every image 100 and are placed in positions that ensure a reasonable degree of correspondence between the landmarks' locations across the images 100. The facial feature extraction module 150 can analyze the facial image to identify the location within the image 100 of the facial organs such as: nose, ears, mouth, eyes, chin, etc. The facial feature extraction module 150 can determine the location of the landmarks in relation to these identified organs. A non-limiting example is of the facial feature extraction module 150 identifying the location of the nose in the image 100. The facial feature extraction module 150 then utilizes this location to determine the location of landmarks that are related to the nose. For our example, determining the location of additional landmarks that are associated with additional facial organs: such as the eyes, the mouth, the chin, etc.

The facial feature extraction module 150 utilizes the landmarks to determine one or more facial features for the image 100. These features can be calculated based on the location of the landmarks within image 100. For example, the first feature can be calculated as the average distance between each of the eyes and the nose with respect to inter-pupil distance (IPD). This first feature can be calculated for image 100 based on the location of the determined landmarks. The facial feature extraction module 150 can calculate additional facial features for the image 100, based on the locations of the corresponding landmarks within the image 100.

The facial feature extraction module 150 can also utilize image 100 to determine features that are not landmarks related. Another example is the facial feature extraction module 150 determining the emotions of the person in the image 100 and calculate and/or evaluate features based on these emotions. For example: the facial feature extraction module 150 can determine that a person is smiling in the image and can calculate a feature of happiness level for that person. Other parts of the image 100 can be utilized by the facial feature extraction module 150 to determine features. In some cases, these other parts of the images can be used to determine additional features, in addition to features determined based on the image 100. For example, the illumination of the background (such as: night, day, horizon, Color Correlated Temperature (CCT), etc.) of the image 100 can be used to calculate features. In another example, scenery in the background of the image 100 can be used to calculate a feature related to travel locations of the captured person or time of day. Features can also be calculated based on other body parts within the image 100, such as: age, gender, Body Mass Index (BMI), height, etc. For example, by calculating a finger feature (based on an index to ring ratio) for the image 100. Features can also be calculated based on garments or other clothing features (such as: glasses, tattoos, earrings, etc.) that appear within the image 100. For example, by calculating a season feature (based on the type of clothes the persons in the images are wearing) for the image 100. In some cases, the facial feature extraction module 150 can utilize one or more machine learning models (such as: supervised learning models, unsupervised learning models, deep learning models, etc.) to determine the features of at least some of the images 100. In addition, the facial feature extraction module 150 can calculate features for the captured persons from supplementary sources that can accompany the images 100, for example: from meta-data obtained with the images 100, from answers to questionnaires provided by the persons captured in the images 100, from sensors sensing the persons (heart rate, sweat, eye blinking rate, etc.), etc. The features can be calculated based on knowledge associated with the domains of anthropology, neurobiology, physiology, neuropsychology, evolutionary biology (morphology, dysmorphology), chemistry and others. At least some of the images 100 of the person associated with the transaction 110 can include other types of imagery (including, non-visual imagery), such as: Functional Magnetic Resonance Imaging or functional MRI (fMRI), spectral imaging in different wavelengths, facial topography, Cloud of Points (COP) from 3D facial scanning, etc.

The second possible embodiment of the risk determination architecture comprises a supervised machine learning model 160, capable of receiving one or more facial features extracted from the image 100 of a person associated with the transaction 110 by the receiving one or more facial features extracted from an image of a person associated with the transaction and determining the risk score associated with the transaction being performed for the person and determining the risk score 140 associated with the transaction 110 being performed for the person.

The supervised machine learning model 160 can be trained utilizing a labeled training-data set comprising of a plurality of records, each record comprising one or more facial features extracted from an image 100 of a person associated with a transaction 110, and wherein at least some records of the records are associated with a label indicative of a risk score 140 associated with the corresponding transaction 110 being performed for the person. The supervised machine learning model 160 is trained to learn the correlation between the facial features and the risk score 140, such that after training is complete, the supervised machine learning model 160 can receive un-labeled facial features and can predict the risk score 140 for those facial features.

The supervised machine learning model 160 can be based on one or more deep learning and/or neural network techniques, for example: Convolutional Neural Networks (CNN), encoders-decoders, Deep Stacking Networks (DSN), Graph Neural Network (GNN) and backpropagation networks, etc., and machine learning techniques such as Support Vector Machine (SVM), eXtreme Gradient Boosting (XGBoost), Light Gradient Boosting Machine (LGBM), etc.

Optionally, the supervised machine learning model 160 can also receive one or more properties of the transaction 110 being performed for the person. In these cases, the supervised machine learning model 160 is capable of determining the risk score 140 associated with the transaction being performed for the person based on the facial features and also based on the one or more properties of the transaction being performed for the person. In these cases, the supervised machine learning model 160 is trained utilizing a labeled training-data comprising of a plurality of records, where each record comprising: facial features extracted of an image 100 of a person associated with a transaction 110, and the one or more properties of the transaction 110, and wherein at least some records of the records are associated with a label indicative of a risk score associated with the corresponding transaction being performed for the person. In these cases, the supervised machine learning model 160 is trained to learn the correlation between the facial features and the properties of the transaction 110 and the risk score 140, such that after training is complete, the supervised machine learning model 160 can receive un-labeled facial features and properties of the transaction 110 and predict the risk score 140 for those facial features associated with the transaction 110.

Optionally, the supervised machine learning model 160 can also receive one or more additional features extracted from the image 100 of the person associated with the transaction 110. In these cases, the supervised machine learning model 160 is capable of determining the risk score 140 associated with the transaction being performed for the person based on the facial features and also based on the one or more additional features. In these cases, the supervised machine learning model 160 is trained utilizing a labeled training-data comprising of a plurality of records, where each record comprising: facial features extracted from an image 100 of a person associated with a transaction 110, and the one or more additional features of the person appearing in image 100, and wherein at least some records of the records are associated with a label indicative of a risk score associated with the corresponding transaction being performed for the person. In these cases, the supervised machine learning model 160 is trained to learn the correlation between the facial features and the additional features and the risk score 140, such that after training is complete, the supervised machine learning model 160 can receive un-labeled facial features and additional features of the person appearing in image 100 and predict the risk score 140 for those facial features associated with the transaction 110. It is to be noted that the additional features can include one or more of: garments-based features of at least part of garments worn by the person appearing in the image 100, body-part features of at least part of a body of the person appearing in the image 100, palm-based features of at least part of a palm of the person appearing in the image 100, background-based features extracted from a background of the image 100, and/or any other additional features associated with image 100. At least one of the additional features can be extracted from the image 100 using an image feature extracting machine learning model.

A non-limiting example of a risk score determination system based on the second embodiment of the risk determination architecture comprises of: a facial features extraction model 150 that is capable of extracting facial features from facial images and a supervised machine learning model 160 that has been trained on labeled data of facial features of images 100 of persons associated with transaction 110 and optionally on properties of transaction 110 and on additional features. This exemplary risk score determination system can receive a given image 100 associated with a new transaction 110, for which risk score 140 needs to be determined. This exemplary risk score determination system utilizes the facial features extraction model 150 to extract one or more facial features from a given image 100. This exemplary risk score determination system then utilizes the supervised machine learning model 160 with the given facial features as an input, and optionally with properties of the new transaction 110 as additional input to determine the risk score 140 of the new transaction 110. Optionally, additional features can be provided to this exemplary risk score determination system, for example, by extracting them from image 100 to be used in the determination of the risk score 140.

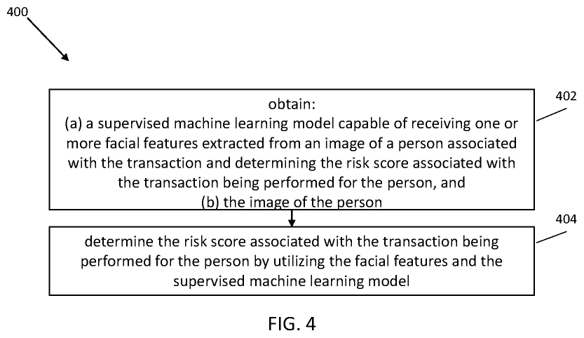

The risk determination system can utilize these models: the facial feature extraction model 150 and the supervised machine learning model 160 to determine the risk score 140 associated with the transaction 110 based on the image 100 that is associated with the transaction 110, as will be further described hereafter in reference to FIG. 4.

Attention is now drawn to FIG. 1C, a schematic illustration of a third possible embodiment of the risk determination architecture, in accordance with the presently disclosed subject matter.

As shown in the schematic illustration, a risk determination system can be devised in accordance with the third possible embodiment of the risk determination architecture. The third possible embodiment of the risk determination architecture comprises at least one image 100 which is associated with the transaction 110, in the manner described above in relation to FIG. 1A. The third possible embodiment of the risk determination architecture comprises a transfer-learning machine learning model 170 capable of receiving the image 100 of a person associated with the transaction 110 and determining the risk score 140 associated with the transaction 110 being performed for the person. The transfer-learning machine learning model 170 can be based on a transformer machine learning architecture as known in the art, such as: Generative Pre-trained Transformer (GPT), Bidirectional Encoder Representations from Transformer (BERT) or other transformer-based machine learning models.

The transfer-learning machine learning model 170 can be trained utilizing supervised training performed on a pre-trained unsupervised machine learning model having an input layer, an output layer and multiple intermediate layers, each intermediate layer comprising nodes with weights, wherein the supervised training is performed while freezing the weights of at least one layer of the layers. In some cases, the one or more frozen layers are intermediate layers preceding the output layer of the pre-trained unsupervised machine learning model. The pre-trained unsupervised machine learning model is pre-trained utilizing an unlabeled training-data set comprising of a plurality of unlabeled images. At least some of the unlabeled images can be gathered randomly from publicly available images (for example: from the Internet).

The transfer-learning machine learning model 170 can be based on one or more deep learning and/or neural network techniques, for example: Convolutional Neural Networks (CNN), encoders-decoders, Deep Stacking Networks (DSN), Graph Neural Network (GNN) and backpropagation networks, etc., and machine learning techniques such as Support Vector Machine (SVM), eXtreme Gradient Boosting (XGBoost), Light Gradient Boosting Machine (LGBM), etc.

The transfer-learning machine learning model 170 can be, for a non-limiting example, a FaceNet machine learning model which is a unified embedding for face recognition and clustering that directly learns a mapping from face images to a compact Euclidean space where distances directly correspond to a measure of face similarity. The FaceNet model can be pre-trained over images of human faces. The FaceNet machine learning model can generate embedding vectors of multiple values. In the third embodiment of the risk determination architecture all or part of the multiple values that represent the image in the vector embedding can be used as the output of the transfer-learning machine learning model 170. It is to be noted that other machine learning models can be used in a similar way to the FaceNet model, such as: DeepFace, ArcFace, OpenFace, Dlib or any other solution that can extract an embedding vector from an image. Another non-limiting example of the transfer-learning machine learning model 170 is comprised of two or more sub-models-that work on the same image to extract an integrated embedding vector that is based on the embedding vectors extracted by one or more of the sub-models.

Optionally, the transfer-learning machine learning model 170 can also receive one or more properties of the transaction 110 being performed for the person. In these cases, the transfer-learning machine learning model 170 is capable of determining the risk score 140 associated with the transaction being performed for the person based on the image 100 and also based on the one or more properties of the transaction being performed for the person. In these cases, the transfer-learning machine learning model 170 is trained utilizing a labeled training-data comprising of a plurality of records, where each record comprising: an image 100 of a person associated with a transaction 110, and the one or more properties of the transaction 110, and wherein at least some records of the records are associated with a label indicative of a risk score associated with the corresponding transaction being performed for the person. In these cases, the transfer-learning machine learning model 170 is trained to learn the correlation between the image 100 and the properties of the transaction 110 and the risk score 140, such that after training is complete, the transfer-learning machine learning model 170 can receive an un-labeled image 100 and properties of the transaction 110 and predict the risk score 140 for that embedding vector associated with the given transaction 110.

Optionally, the transfer-learning machine learning model 170 can also receive one or more facial features extracted from the image 100 of the person associated with the transaction 110. It is notable that face structure (and features) is unique. Each individual has its personality manifested in his or her own face structure (and features). Human faces have evolved to signal and/or reflect individual identity in human interaction. Facial structure (and features) can be utilized to determine risks. The structure of the face reflects the genetic characteristics of that individual. Facial structure exposes the individual's health, parental suitability, level of aggressiveness, and more.

In these cases, the transfer-learning machine learning model 170 is capable of determining the risk score 140 associated with the transaction being performed for the person based on the image 100 and also based on the one or more facial features. In these cases, the transfer-learning machine learning model 170 is trained utilizing a labeled training-data comprising of a plurality of records, where each record comprising: an image 100 of a person associated with a transaction 110, and the one or more facial features of a face of the person appearing in image 100, and wherein at least some records of the records are associated with a label indicative of a risk score associated with the corresponding transaction being performed for the person. In these cases, the transfer-learning machine learning model 170 is trained to learn the correlation between the image 100 and the facial features and the risk score 140, such that after training is complete, the transfer-learning machine learning model 170 can receive an un-labeled image 100 and predict the risk score 140 for that image 100 associated with the transaction 110. It is to be noted that the facial features can include one or more of: facial landmarks features extracted from a face of the person appearing in the image 100, biological features of the person appearing in the image 100, genetic system features of the person appearing in the image 100, hormonal system features of the person appearing in the image 100, immune system features of the person appearing in the image 100, psychological features of the person appearing in the image 100, emotional features of the person appearing in the image 100, and/or any other facial features of the person appearing in the image 100. At least one of the facial features can be extracted from the image 100 using a facial image feature extracting machine learning model.

Optionally, the transfer-learning machine learning model 170 can also receive one or more additional features extracted from the image 100 of the person associated with the transaction 110. In these cases, the supervised machine learning model 130 is capable of determining the risk score 140 associated with the transaction being performed for the person based on the image 100 and also based on the one or more additional features. In these cases, the transfer-learning machine learning model 170 is trained utilizing a labeled training-data comprising of a plurality of records, where each record comprising: an image 100 of a person associated with a transaction 110, and the one or more additional features of the person appearing in image 100, and wherein at least some records of the records are associated with a label indicative of a risk score 140 associated with the corresponding transaction 110 being performed for the person. In these cases, the transfer-learning machine learning model 170 is trained to learn the correlation between image 100 and the additional features and the risk score 140, such that after training is complete, the transfer-learning machine learning model 170 can receive an un-labeled image 100 and additional features of the person appearing in the image 100 and predict the risk score 140 for that image 100 associated with the transaction 110. It is to be noted that the additional features can include one or more of: garments-based features of at least part of garments worn by the person appearing in the image 100, body-part features of at least part of a body of the person appearing in the image 100, palm-based features of at least part of a palm of the person appearing in the image 100, background-based features extracted from a background of the image 100, and/or any other additional features associated with image 100. At least one of the additional features can be extracted from the image 100 using an image feature extracting machine learning model.

A non-limiting example of a risk score determination system based on the third embodiment of the risk determination architecture comprises of: a transfer-learning machine learning model 170 that has been trained on unlabeled images and then fine-tuned training while freezing the weights of zero or more of the model's layers with labeled data of the images 100 of persons associated with the transaction 110 and optionally on properties of the transaction 110 and on additional features. This exemplary risk score determination system can receive a given image 100 associated with a new transaction 110, for which the risk score 140 needs to be determined. This exemplary risk score determination system utilizes the transfer-learning machine learning model 170 with the given image 100 as an input, and optionally with properties of the new transaction 110 as additional input to determine the risk score 140 of the new transaction 110. Optionally, additional features can be provided to this exemplary risk score determination system, for example, by extracting them from the image 100 to be used in the determination of the risk score 140.

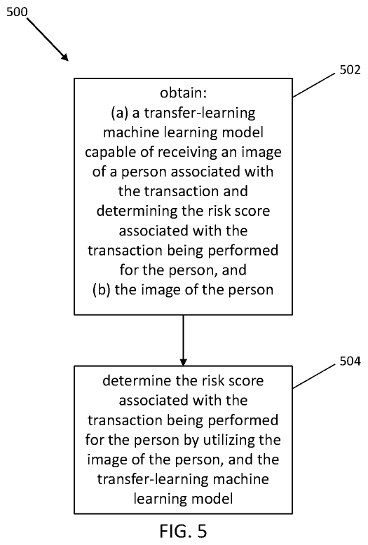

The risk determination system can utilize these models: the transfer-learning machine learning model 170 to determine the risk score 140 associated with a transaction 110 based on an image 100 that is associated with the transaction 110, as will be further described hereafter in reference to FIG. 5.

After describing possible embodiments for the risk determination architecture, attention is now drawn to a description of the components of a risk determination system.

FIG. 2 is a block diagram schematically illustrating one example of a risk determination system 200 that can be devised in accordance with any one of the possible embodiments for the risk determination architecture and/or any combination thereof, in accordance with the presently disclosed subject matter.

In accordance with the presently disclosed subject matter, the risk determination system 200 (also interchangeably referred to herein as “risk score determination system 200” and/or “system 200”) can comprise a network interface 206. The network interface 206 (e.g., a network card, a Wi-Fi client, a Li-Fi client, 3G/4G/5G client, satellite communications or any other component), enables system 200 to communicate over a network with external systems and handles inbound and outbound communications from such systems. For example, system 200 can receive and/or send, through network interface 206, at least one image 100, data about one or more transactions 110 and their respective properties, one or more machine learning models (such as: unsupervised machine learning model 120, supervised machine learning model 130, supervised machine learning model 160, transfer-learning machine learning model 170, etc.), training data-sets used to train machine learning models, risk scores 140, etc.

System 200 can further comprise or be otherwise associated with a data repository 204 (e.g., a database, a storage system, a memory including Read Only Memory-ROM, Random Access Memory-RAM, or any other type of memory, etc.) configured to store data. Some examples of data that can be stored in the data repository 204 include: at least one image 100, data about one or more transactions 110 and their respective properties, one or more machine learning models (such as: unsupervised machine learning model 120, supervised machine learning model 130, supervised machine learning model 160, transfer-learning machine learning model 170, etc.), training data-sets used to train machine learning models, risk scores 140, etc. Data repository 204 can be further configured to enable retrieval and/or update and/or deletion of the stored data. It is to be noted that in some cases, data repository 204 can be distributed, while system 200 has access to the information stored thereon, e.g., via a wired or wireless network to which system 200 is able to connect (utilizing its network interface 206).

System 200 further comprises processing circuitry 202. Processing circuitry 202 can be one or more processing units (e.g., central processing units), microprocessors, microcontrollers (e.g., microcontroller units (MCUs) cloud servers, graphical processing units (GPUs), or any other computing devices or modules, including multiple and/or parallel and/or distributed processing units, which are adapted to independently or cooperatively process data for controlling relevant system 200 resources and for enabling operations related to system's 200 resources.

The processing circuitry 202 comprises a risk score determination module 208 that uses unsupervised and supervised machine learning models, configured to perform a first risk score determination process, as further detailed herein, inter alia with reference to FIG. 3.

The processing circuitry 202 comprises a risk score determination module 210 that uses feature extraction and supervised machine learning models, configured to perform a second risk score determination process, as further detailed herein, inter alia with reference to FIG. 4.

The processing circuitry 202 comprises a risk score determination module 212 that uses transfer-learning machine learning models, configured to perform a third risk score determination process, as further detailed herein, inter alia with reference to FIG. 5.

It should be noted that the one or more of the modules (risk score determination using unsupervised and supervised machine learning models module 208, risk score determination using feature extraction and supervised machine learning models module 210, and/or risk score determination using a transfer-learning machine learning model module 212) can be optional. System 200 can operate with one or more of the models (risk score determination using unsupervised and supervised machine learning models module 208, risk score determination using feature extraction and supervised machine learning models module 210, and/or risk score determination using a transfer-learning machine learning model module 212). System 200 can work with the models in parallel, where the models (risk score determination using unsupervised and supervised machine learning models module 208, risk score determination using feature extraction and supervised machine learning models module 210, and/or risk score determination using a transfer-learning machine learning model module 212), and/or work in a sequential mode, where the models (risk score determination using unsupervised and supervised machine learning models module 208, risk score determination using feature extraction and supervised machine learning models module 210, and/or risk score determination using a transfer-learning machine learning model module 212) are not used simultaneously, and/or work in some combination of parallel and sequential modes.

It should be noted that system 200 can operate as a standalone system without the need for network interface 206 and/or data repository 204. Adding one or both of these elements to system 200 is optional and not mandatory, as system 200 can operate according to its intended use either way.

Turning to FIG. 3 there is shown a flowchart illustrating an example of a sequence of operations carried out by a first embodiment of the risk determination system, in accordance with the presently disclosed subject matter.

Accordingly, the risk determination system 200 can be configured to perform a first risk score determination process 300, e.g., using the risk score determination using unsupervised and supervised machine learning models module 208 that uses unsupervised and supervised machine learning models to determine risk.

The risk determination system 200 can be devised in accordance with the first embodiment of the risk determination architecture. The risk determination system 200 can determine a risk score 140 for a transaction 110 based on an image 100 that is associated with the transaction 110. The image 100 can be an image of a person that the transaction 110 is performed for. In some cases, the risk determination system 200 can determine a risk score 140 for a transaction 110 based on image 100 only. In other cases, the risk determination system 200 can determine a risk score 140 for a transaction 110 based on image 100 and on additional information. The determination of risk score 140 can be also based on properties of the transaction 110. The determination of risk score 140 can be also based on facial features extracted from image 100. The determination of risk score 140 can be also based on facial features extracted from a facial image appearing within image 100. The determination of risk score 140 can be also based on additional features extracted from image 100. A non-limiting example is of a financial transaction given by a service provider, such as: a loan. In our non-limiting example, the service provider is a bank providing financial services in the Indian sub-continent, Latin America, Africa, south east Asia, east Europe or any other place in the world. The bank can utilize system 200 to determine the risk score for the loan based on the image 100. The person captured in image 100 can be the person requesting the loan from the bank. The risk determination system 200 can also utilize parameters of transaction 110 for the determination of the risk score 140, in our example these parameters can include: loan starting date, loan ending date, loan currency, loan amount, loan interest rate, number of installments for the loan, and/or any other properties of the loan.

For this purpose, risk score determination system 200 obtains: (a) the unsupervised machine learning model 120 capable of receiving the image 100 of the person associated with the transaction 110 and calculating and/or extracting an embedding vector for the image 100, (b) the supervised machine learning model 130 capable of receiving an embedding vector of the image 100 and determining the risk score 140 associated with the transaction 110 being performed for the person, and (c) the image 100 of a given person that is associated with a transaction 110 for which a risk score 140 us to be determined and/or assessed (block 302). The image 100 can be one or more of and/or extracted from one or more of: a static two-dimensional facial image of the person associated with the transaction 110, a static three-dimensional facial image of the person associated with the transaction 110, a static two-dimensional image of the person associated with the transaction 110, a static three-dimensional facial model of the person associated with the transaction 110, a two-dimensional static facial model of the person associated with the transaction 110, a static three-dimensional image of the person associated with the transaction 110, a moving image of the person associated with the transaction 110, an analog video clip of the person associated with the transaction 110, a digital video clip of the person associated with the transaction 110, any imagery source associated with the person, and/or any other imagery source associated with the transaction 110. In cases where image 100 is a static three-dimensional facial image of the person associated with the transaction 110, it can be generated from one or more of: a hologram of the person associated with the transaction 110, a static two-dimensional image of the person associated with the transaction 110, a static three-dimensional image of the person associated with the transaction 110, and/or generated from any other image source. It is to be noted that the image 100 of the person can be captured from one or more imagery sources, for example: from a video recording of the person associated with the transaction 110, from a static two-dimensional image of the person associated with the transaction 110, from a static three-dimensional image of the person associated with the transaction 110 or from any other imagery source.

Continuing our non-limiting example above, the transaction 110 can be a new loan request that has been requested from the bank by a given person. The bank has obtained, as part of the loan request process, the image 100 of the given person (for example, by having the given person take a selfie with his or her smartphone). The unsupervised machine learning model 120 has been pre-trained on facial images taken randomly from the Internet to generate an embedding vector for each inputted facial image. Optionally, unsupervised machine learning model 120 has been pre-trained on facial images of people from a certain region—in our example: images of people from the Indian sub-continent, Latin America, Africa, south east Asia, east Europe or any other place in the world. This can result in more efficient results by the pre-trained unsupervised machine learning model 120. The supervised machine learning model 130 has been trained on labeled data that includes: embedding vectors generated from facial images of persons that took loans in the past and a corresponding actual risk score for that loan. For example: a defaulted past loan will have a corresponding risk level score of “High”. Optionally, the risk score determination system 200 can obtain one or more properties of transaction 110, such as: loan starting date, loan ending date, loan currency, loan amount, loan interest rate, number of installments for the loan, and/or any other properties of the loan, etc. In these cases, the supervised machine learning model 130 has been trained also on the properties of the transaction to predict the risk score 140 for the new loan request.

Once the unsupervised machine learning model 120, the supervised machine learning model 130 and the image 100 are obtained, system 200 calculates and/or extracts the embedding vector of the image 100 by utilizing the image of the person and the unsupervised machine learning model 120 (block 304). Continuing the above non-limiting example, system 200 calculates and/or extracts a given embedding vector by inputting the image 100 capturing the given person that has requested the new loan request for which risk determination system 200 is determining the risk score 140.

Risk determination system 200 can then determine the risk score 140 associated with the transaction 110 being performed for the person associated with image 100 by utilizing the calculated embedding vector and the supervised machine learning model 130 (block 306). Continuing the above non-limiting example, risk determination system 200 utilizes the calculated given embedding vector as input to the supervised machine learning model 130. The output of the supervised machine learning model 130 is the risk score 140 determined for the new transaction 110. The bank can use the risk score 140 determined by the risk determination system 200 to decide whether to approve or disapprove the new loan to the given person. The bank can also decide on requesting additional information from the person requesting the loan and/or decide to approve a different transaction than the one requested by the person-all in view of the risk score 140. Optionally, the risk determination system 200 can utilize properties of the transaction 110, facial features and other features extracted from image 100 and/or from other sources to determine the risk score 140. In these cases, the supervised machine learning model 130 can receive as input one or more of the properties of the new transaction 110, facial features and other features extracted from the image 100 of the given person to determine the risk score 140 associated with the new transaction 110.

It is to be noted, with reference to FIG. 3, that some of the blocks can be integrated, mutatis mutandis, into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Turning to FIG. 4 there is shown a flowchart illustrating an example of a sequence of operations carried out by a second embodiment of the risk determination system, in accordance with the presently disclosed subject matter.

Accordingly, the risk determination system 200 can be configured to perform a second risk score determination process 400, e.g., using the risk score determination using feature extraction and the supervised machine learning models module 210 that uses feature extraction and supervised machine learning models to determine risk.

The risk determination system 200 can be devised in accordance with the second embodiment of the risk determination architecture. The risk determination system 200 can determine the risk score 140 for the transaction 110 based on facial features extracted from the image 100 that is associated with the transaction 110. The image 100 can be an image of a person that the transaction 110 is performed for. In some cases, the risk determination system 200 can determine a risk score 140 for a transaction 110 based on image 100 only. In other cases, the risk determination system 200 can determine a risk score 140 for a transaction 110 based on image 100 and on additional information. The determination of risk score 140 can be also based on properties of the transaction 110. The determination of risk score 140 can be also based on additional features extracted from the image 100. A non-limiting example is of an insurance transaction for evaluating an insurance policy for a given person. In our non-limiting example, the service provider is an insurance company providing insurance services. The insurance company can utilize system 200 to determine the risk score for the insurance policy for the given person based on the image 100. The person captured in image 100 can be the person requesting the insurance policy from the insurance company. The risk determination system 200 can also utilize parameters of the transaction 110 for the determination of the risk score 140, in our example these parameters can include: insurance policy amount, insurance policy currency, insurance policy starting date, insurance policy ending date, insurance policy premium, or insurance policy number of installments, and/or any other properties of the insurance policy.

For this purpose, the risk score determination system 200 obtains: (a) the supervised machine learning model 160 capable of receiving one or more facial features extracted from an image of a person associated with the transaction 110 by a facial feature extraction module and determining the risk score 140 associated with the transaction 110 being performed for the person, and (b) the image 100 of a given person that is associated with the transaction 110 for which the risk score 140 is to be determined and/or assessed (block 402). The image 100 can be one or more of and/or extracted from one or more of: a static two-dimensional facial image of the person associated with the transaction 110, a static three-dimensional facial image of the person associated with the transaction 110, a static two-dimensional image of the person associated with the transaction 110, a static three-dimensional facial model of the person associated with the transaction 110, a two-dimensional static facial model of the person associated with the transaction 110, a static three-dimensional image of the person associated with the transaction 110, a moving image of the person associated with the transaction 110, an analog video clip of the person associated with the transaction 110, a digital video clip of the person associated with the transaction 110, any imagery source associated with the person, and/or any other imagery source associated with the transaction 110. In cases where image 100 is a static three-dimensional facial image of the person associated with the transaction 110, it can be generated from one or more of: a hologram of the person associated with the transaction 110, a static two-dimensional image of the person associated with the transaction 110, a static three-dimensional image of the person associated with the transaction 110, and/or generated from any other image source. It is to be noted that the image 100 of the person can be captured from one or more imagery sources, for example: from a video recording of the person associated with the transaction 110, from a static two-dimensional image of the person associated with the transaction 110, from a static three-dimensional image of the person associated with the transaction 110 or from any other imagery source.

Continuing our non-limiting example above, the transaction 110 can be a new insurance policy request that has been requested from the insurance company by a given person. The insurance company has obtained, as part of the insurance policy request process, the image 100 of the given person (for example, by having the given person take a selfie with his or her smartphone). The supervised machine learning model 160 has been trained on labeled data that includes: facial features extracted from facial images of persons that received insurance policies in the past and a corresponding actual risk score for that insurance policy. For example: an insurance policy with claims above a threshold will have a corresponding risk level score of “High”. Optionally, the risk score determination system 200 can obtain one or more properties of the transaction 110, such as: insurance policy amount, insurance policy start date, etc. In these cases, the supervised machine learning model 160 has been trained also on the properties of the transaction to predict the risk score 140 for the new insurance policy.

Once the supervised machine learning model 160 and the image 100 are obtained, risk determination system 200 can determine the risk score 140 associated with the transaction 110 being performed for the person associated with image 100 by utilizing the facial features extracted from image 100 by the facial feature extraction module 150 and the supervised machine learning model 160 (block 404). Continuing the above non-limiting example, risk determination system 200 utilizes the facial features extracted from image 100 by the facial feature extraction module 150 as input to the supervised machine learning model 160. The output of the supervised machine learning model 160 is the risk score 140 determined for the new transaction 110. The insurance company can use the risk score 140 determined by the risk determination system 200 to decide if to approve or disapprove the new insurance policy, and/or decide to approve a different transaction than the one requested by the person-all in view of the risk score 140 for the given person. The insurance company can also decide on requesting additional information from the person requesting the insurance policy in view of the risk score 140. Optionally, the risk determination system 200 can utilize properties of the transaction 110, and/or other features extracted from image 100 and/or from other sources to determine the risk score 140. In these cases, the supervised machine learning model 140 can receive as input one or more of the properties of the new transaction 110, and/or other features extracted from the image 100 of the given person to determine the risk score 140 associated with the new transaction 110.

It is to be noted that in some cases, risk determination system 200 can obtain two or more images representing the given person. These two or more images can be a series of images taken over time or can be extracted from a video (for example: from a video file, from a live video clip, etc.) representing the given person. The two or more images can be used to generate a relative three-dimensional model of the person and specifically a three-dimensional model of the person's face. In some cases, the three-dimensional model of the given person, and specifically the three-dimensional model of the given person's face, can be generated directly from a video representing the given person (for example, a video where the given person appears in one or more of its frames). The three-dimensional model can be generated for example by identifying the organs such as the mouth, nose or the eyes or the anatomical landmarks of the given person in the two or more images, and using their location to create the three-dimensional model. The three-dimensional model of the person, and specifically the three-dimensional model of the person's face, can be utilized by the system 200 to determine the three-dimensional landmarks and calculate the given persons' facial features. These facial features are more accurate than features calculated based on landmarks from a static two-dimensional image. For example, a wrinkle in the face of the given person is modeled in the three-dimensional model and the facial landmarks are then determined by the system 200 that analyzes the three-dimensional shape of the wrinkle, including its depth, as part of the landmark determination. The same methods of extracting facial features from three-dimensional models can be used by the facial feature extraction model 150. It is to be noted that three-dimensional models support easily creation of synthetic training data by using machine learning methods, such as: Generative Adversarial Network (GAN), to generate synthetic images from a base three-dimensional model by adding one or more variations to the base three-dimensional model thereby creating a series of synthetic variants of the base three-dimensional models.

It is to be noted, with reference to FIG. 4, that some of the blocks can be integrated, mutatis mutandis, into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Turning to FIG. 5 there is shown a flowchart illustrating an example of a sequence of operations carried out by a third embodiment of the risk determination system, with respect to the presently disclosed subject matter.

Accordingly, the risk determination system 200 can be configured to perform a third risk score determination process 500, e.g., using the risk score determination using a transfer-learning machine learning model module 212 that uses transfer-learning machine learning models to determine the risk.

The risk determination system 200 can be devised in accordance with the third embodiment of the risk determination architecture. The risk determination system 200 can determine a risk score 140 for a transaction 110 based on an image 100 that is associated with the transaction 110. The image 100 can be an image of a person that the transaction 110 is performed for. In some cases, the risk determination system 200 can determine a risk score 140 for a transaction 110 based on image 100 only. In other cases, the risk determination system 200 can determine a risk score 140 for a transaction 110 based on image 100 and on additional information. The determination of risk score 140 can be also based on properties of the transaction 110. The determination of risk score 140 can be also based on facial features and/or additional features extracted from the image 100. A non-limiting example is of a security transaction for evaluating and/or providing clearance for a given person. In our non-limiting example, the service provider is a security service provider providing security clearance services of the given person. The security service provider can utilize system 200 to determine the risk score which represents the security risk associated with the given person based on the image 100. The person captured in the image 100 can be the person requesting the clearance from the security service provider. The risk determination system 200 can also utilize parameters of transaction 110 for the determination of the risk score 140, in our example these parameters can include: security transaction date, existing levels of security clearance for the given person, level of clearance requested for the given person, historical travel information for the given person, family members information for the given person, friends information for the given person, historical publications of the given person, historical security information for the given person, counter-security activities of the given person, and/or any other properties of the security transaction.

For this purpose, the risk score determination system 200 obtains: (a) the transfer-learning machine learning model 170 capable of receiving the image 100 of a person associated with the transaction 110 and determining the risk score 140 associated with the transaction being performed for the person, and (b) the image 100 of a given person that is associated with a transaction 110 for which a risk score 140 us to be determined and/or assessed (block 502). The image 100 can be one or more of and/or extracted from one or more of: a static two-dimensional facial image of the person associated with the transaction 110, a static three-dimensional facial image of the person associated with the transaction 110, a static two-dimensional image of the person associated with the transaction 110, a static three-dimensional facial model of the person associated with the transaction 110, a two-dimensional static facial model of the person associated with the transaction 110, a static three-dimensional image of the person associated with the transaction 110, a moving image of the person associated with the transaction 110, an analog video clip of the person associated with the transaction 110, a digital video clip of the person associated with the transaction 110, any imagery source associated with the person, and/or any other imagery source associated with the transaction 110. In cases where image 100 is a static three-dimensional facial image of the person associated with the transaction 110, it can be generated from one or more of: a hologram of the person associated with the transaction 110, a static two-dimensional image of the person associated with the transaction 110, a static three-dimensional image of the person associated with the transaction 110, and/or generated from any other image source. It is to be noted that the image 100 of the person can be captured from one or more imagery sources, for example: from a video recording of the person associated with the transaction 110, from a static two-dimensional image of the person associated with the transaction 110, from a static three-dimensional image of the person associated with the transaction 110 or from any other imagery source.

Continuing our non-limiting example above, the transaction 110 can be a new clearance process that has been initiated by the security service provider for clearing a given person. The security service provider has obtained, as part of the clearance process, the image 100 of the given person (for example, by having the given person take a selfie with his or her smartphone). The transfer-learning machine learning model 170 has been pre-trained on facial images taken randomly from the Internet to generate the risk score 140 for each inputted facial image. The transfer-learning machine learning model 170 can be trained utilizing supervised training performed on a pre-trained unsupervised machine learning model having an input layer, an output layer and multiple intermediate layers, each intermediate layer comprising nodes with weights, wherein the supervised training is performed while freezing the weights of at least one layer of the layers. In some cases, the one or more frozen layers are intermediate layers preceding the output layer of the pre-trained unsupervised machine learning model. The pre-trained unsupervised machine learning model is pre-trained utilizing an unlabeled training-data set comprising of a plurality of unlabeled images. At least some of the unlabeled images can be gathered randomly from publicly available images (for example: from the Internet). Optionally, transfer-learning machine learning model 170 can be pre-trained on facial images of people from a certain region—in our example: images of people that are from Latin America, Africa, south east Asia, east Europe or any other place in the world. After pre-training the transfer-learning machine learning model 170 it can undergo a supervised training stage with labeled training data of images and their respective risk scores 140. The labeled data can also include: facial features extracted from facial images of persons that received clearance in the past and a corresponding actual risk score for that clearance. For example: a clearance to a person that later breached security will have a corresponding risk level score of “High”. Optionally, the risk score determination system 200 can obtain one or more properties of the transaction 110, such as: the transaction 110 date, existing levels of security clearance for the given person, etc., and/or facial features and/or additional features extracted from the image 100 and/or additional features extracted from the transaction 110. In these cases, the transfer-learning machine learning model 170 has been trained (in the supervised training stage) also on the properties of the transaction 110 and/or the facial features and/or the additional features extracted from image 100 to predict the risk score 140 for the clearance process.

Once the transfer-learning machine learning model 170 and the image 100 are obtained, the risk determination system 200 can determine the risk score 140 associated with the transaction 110 being performed for the person associated with the image 100 by utilizing the image 100 and the transfer-learning machine learning model 170 (block 504). Continuing the above non-limiting example, the risk determination system 200 utilizes the image 100 as input to the transfer-learning machine learning model 170. The output of the transfer-learning machine learning model 170 is the risk score 140 determined for the new security transaction 110. The security service provider can use the risk score 140 determined by the risk determination system 200 to decide if to approve or disapprove the new insurance policy, and/or decide to approve a different transaction than the one requested for the person-all in view of the risk score 140 for the given person. Optionally, the security service provider can also decide on requesting additional information from the person that the clearance is performed for in view of the risk score 140. Optionally, the risk determination system 200 can utilize properties of the transaction 110 and/or facial features and/or other features extracted from image 100 and/or from other sources to determine the risk score 140. In these cases, the transfer-learning machine learning model 170 can receive as input one or more of the properties of the new security transaction 110 and/or facial features and/or other features extracted from the image 100 of the given person to determine the risk score 140 associated with the new security transaction 110.

It is to be noted, with reference to FIG. 5, that some of the blocks can be integrated, mutatis mutandis, into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1.-82. (canceled)

83. A system for determining a risk score associated with a transaction, the system comprising a processing circuitry configured to:
obtain:
(a) a transfer-learning machine learning model capable of receiving an image of a person associated with the transaction and determining the risk score associated with the transaction being performed for the person, and
(b) the image of the person; and
determine the risk score associated with the transaction being performed for the person by utilizing the image of the person, and the transfer-learning machine learning model.

84. The system of claim 83, wherein the transfer-learning machine learning model is trained utilizing supervised training performed on a pre-trained unsupervised machine learning model having an input layer, an output layer and multiple intermediate layers, each intermediate layer comprising nodes with weights, wherein the supervised training is performed while freezing the weights of at least one layer of the layers.

85. The system of claim 84, wherein the one or more frozen layers are intermediate layers preceding the output layer of the pre-trained unsupervised machine learning model

86. The system of claim 84, wherein the pre-trained unsupervised machine learning model is pre-trained utilizing an unlabeled training-data set comprising of a plurality of unlabeled images.

87. (canceled)

88. The system of claim 86, wherein the unlabeled images comprise of images of persons from a given region.

89.-91. (canceled)

92. The system of claim 83, wherein: (a) the processing circuitry is further configured to obtain one or more properties of the transaction being performed for the person, (b) the transfer-learning machine learning model is also capable of receiving one or more properties of the transaction being performed for the person, and (c) the determination of the risk score associated with the transaction being performed for the person also utilizes the one or more properties of the transaction being performed for the person.

93. The system of claim 92, wherein: (a) the transaction is a financial transaction for approving a financial service to the person, and (b) the properties of the financial transaction include one or more of: financial service starting date, financial service ending date, financial service currency, financial service amount, financial service interest rate, or number of installments for the financial service.

94. The system of claim 92, wherein: (a) the transaction is an insurance transaction for approving an insurance policy to the person, and (b) the properties of the insurance transaction include one or more of: insurance policy amount, insurance policy currency, insurance policy starting date, insurance policy ending date, insurance policy premium, or insurance policy number of installments.

95. (canceled)

96. The system of claim 92, wherein: (a) the transaction is a human resource transaction for recruitment of the person into a team, and (b) the properties of the human resource transaction include one or more of: team size, images of the team members, team task, professions of the team members, or gender of the team members.

97.-103. (canceled)

104. The system of claim 92, wherein the transfer-learning machine learning model is trained utilizing a labeled training-data comprising of a plurality of records, each record comprising: (i) a given image of a given person associated with a given transaction, and (ii) properties of the given transaction, and wherein at least some given records of the records are associated with a label indicative of a given risk score associated with the corresponding given transaction being performed for the given person.

105. (canceled)

106. (canceled)

107. A method for determining a risk score associated with a transaction, the method comprising:
obtaining, by a processing circuitry:
(a) a transfer-learning machine learning model capable of receiving an image of a person associated with the transaction and determining the risk score associated with the transaction being performed for the person, and
(b) the image of the person; and
determining, by the processing circuitry, the risk score associated with the transaction being performed for the person by utilizing the image of the person, and the transfer-learning machine learning model.

108. The method of claim 107, wherein the transfer-learning machine learning model is trained utilizing supervised training performed on a pre-trained unsupervised machine learning model having an input layer, an output layer and multiple intermediate layers, each intermediate layer comprising nodes with weights, wherein the supervised training is performed while freezing the weights of at least one layer of the layers.

109. The method of claim 108, wherein the one or more frozen layers are intermediate layers preceding the output layer of the pre-trained unsupervised machine learning model.

110. The method of claim 108, wherein: (i) the pre-trained unsupervised machine learning model is pre-trained utilizing an unlabeled training-data set comprising of a plurality of unlabeled images, (ii) the unlabeled images comprise of images of persons from a given region.

111.-115. (canceled)

116. The method of claim 107, wherein: (a) the processing circuitry is further configured to obtain one or more properties of the transaction being performed for the person, (b) the transfer-learning machine learning model is also capable of receiving one or more properties of the transaction being performed for the person, and (c) the determination of the risk score associated with the transaction being performed for the person also utilizes the one or more properties of the transaction being performed for the person.

117. The method of claim 116, wherein: (a) the transaction is a financial transaction for approving a financial service to the person, and (b) the properties of the financial transaction include one or more of: financial service starting date, financial service ending date, financial service currency, financial service amount, financial service interest rate, or number of installments for the financial service.

118. The method of claim 116, wherein: (a) the transaction is an insurance transaction for approving an insurance policy to the person, and (b) the properties of the insurance transaction include one or more of: insurance policy amount, insurance policy currency, insurance policy starting date, insurance policy ending date, insurance policy premium, or insurance policy number of installments.

119. (canceled)

120. The method of claim 116, wherein: (a) the transaction is a human resource transaction for recruitment of the person into a team, and (b) the properties of the human resource transaction include one or more of: team size, images of the team members, team task, professions of the team members, or gender of the team members.

121.-127. (canceled)

128. The method of claim 116, wherein the transfer-learning machine learning model is trained utilizing a labeled training-data comprising of a plurality of records, each record comprising: (i) a given image of a given person associated with a given transaction, and (ii) properties of the given transaction, and wherein at least some given records of the records are associated with a label indicative of a given risk score associated with the corresponding given transaction being performed for the given person.

129. (canceled)

130. (canceled)

131. A non-transitory computer readable storage medium having computer readable program code embodied therewith, the computer readable program code, executable by at least one processing circuitry of a computer to perform a method for determining a risk score associated with a transaction, the method comprising:
obtaining, by a processing circuitry:
(a) a transfer-learning machine learning model capable of receiving an image of a person associated with the transaction and determining the risk score associated with the transaction being performed for the person, and
(b) the image of the person; and
determining, by the processing circuitry, the risk score associated with the transaction being performed for the person by utilizing the image of the person, and the transfer-learning machine learning model.
